(19) United States
(12) Patent Application Publication
(10) Pub. No.: US 2013/0164804 A1
(43) Pub. Date: Jun. 27, 2013

(54) Low Severity Pretreatment of Lignocellulosic Biomass

(71) Applicants: David C. Walther, Oakland, CA (US); William F. McDonald, Utica, OH (US)

(72) Inventors: David C. Walther, Oakland, CA (US); William F. McDonald, Utica, OH (US)

(21) Appl. No.: 13/722,761

(22) Filed: Dec. 20, 2012

Related U.S. Application Data
(60) Provisional application No. 61/580,631, filed on Dec. 27, 2011.
(60) Provisional application No. 61/696,089, filed on Aug. 31, 2012.

(51) Int. Cl. C08B 1/00

(52) U.S. Cl. CPC C08B 1/003
USPC 435/150; 435/160; 435/161; 127/36

(57) ABSTRACT

Methods are provided for preparing a hydrolysate containing soluble sugar molecules from biomass that contains cellulose and hemicellulose. Hemicellulose sugars are extracted in the process, and the resulting hydrolysate may be used to support microbial fermentation to produce products of interest.

### CROSS-REFERENCE TO RELATED APPLICATIONS

This application claims the benefit of U.S. Provisional Application No. 61/580,631, filed on Dec. 27, 2011, and U.S. Provisional Application No. 61/696,089, filed on Aug. 31, 2012, both of which are incorporated by reference herein in their entireties.

### FIELD OF THE INVENTION

The invention relates to a method for extracting soluble sugar molecules from biomass material, optionally with deconstruction of residual cellulose, and compositions prepared by such methods.

### BACKGROUND OF THE INVENTION

Many useful products may be produced by microorganisms grown in culture. A carbon source for such cultures is often provided by hydrolysis of cellulosic biomass materials. Soluble sugar molecules released by hydrolysis may be used to support microbial growth. Hydrolysis of biomass material is often hindered due to the structural nature of the material, which limits access of a catalyst, such as acid, to the polymeric carbohydrate substrate molecules.

Biomass can be pretreated using any number of approaches, each with it its own set of pros and cons. For instance; autohydrolysis and compressed hot water simply uses the acetic acid generated during the water based cook of the biomass to catalyze the breakdown of hemicellulose to oligoxylose and a small amount of free sugar. These oligomers still require further processing to make monomeric sugars for fermentation. The material may be pressed to remove the free sugars and oligomers followed by a steam explosion or rapid expansion process that causes the cellulose component to become more accessible and digestible to the enzymatic process to produce glucose.

Another pretreatment approach is the use of solvents along with acids and bases. This approach is generally called an organosolve pretreatment. It works by using the acid or base to “loosen” or break up the lignin and hemicellulose in conjunction with the solvent. The solvent carries these loosened materials away with the goal of making the cellulose more digestible to the cellulolytic enzymes. This approach typically requires large volumes of solvents and does not necessarily do a good job of recycling solvents for reuse. The solvent can be partially retained in the biomass stream causing problems with enzymes and fermentation organisms.

A third mainstream approach for biomass pretreatment is dilute acid catalysis for the degradation of the polysaccharides to monomeric sugars. This approach typically uses sulfuric acid as it is the least expensive mineral acid available. The dilute acid pretreatment (DAPT) can be used in at least two different process approaches. One approach uses a single stage reaction and combines the acid with a fairly high temperature and short reaction time. The high temperature is conducive to the generation of inhibitors including furfural and hydroxymethyl furfural (HMF) from sugar degradation and phenolic compounds hydrolyzed from lignin. The second dilute acid approach uses two process stages and more optimally catalyzes the degradation of the hemicellulose to hemicellulose sugars, typically xylose for agricultural residues and some forestry products in stage 1, and then uses higher temperatures in stage 2 to process the cellulose to make it more digestible to the enzymes. Even the two stage process suffers from inhibitor generation, leading to inhibition of enzyme activity and microbial growth.

High temperatures used during pretreatment of lignocellulosic substrate to produce soluble sugar molecules cause at least two problems. The first problem is the production of furfural from the dehydration of xylose. The second is the production of phenolic fragments from lignin caused by lignin solubilization and hydrolysis (e.g., treatment above the glass transition temperature of lignin), and the acid hydrolysis of some of these lignin fragments).

New methods are needed that enhance the extractability of soluble sugar molecules from biomass material, while limiting the generation of compounds that may inhibit downstream processing steps and/or growth of microorganisms for bioproduct production.

### BRIEF SUMMARY OF THE INVENTION

Methods for deconstructing biomass and extracting soluble sugar molecules are provided. Methods for use of the resulting hydrolysate in downstream processes for production of bioproducts are also provided.

In one aspect, a method is provided for deconstructing biomass that contains cellulose and hemicellulose for the extraction of sugar molecules from the biomass. In one embodiment, a method is provided for deconstructing and extracting sugar molecules from biomass, including: (a) mechanically disintegrating (e.g., reducing the particle size of) the biomass in the presence of water and under a first pressure, thereby producing liquid and/or vapor and solid disintegrated (e.g., size reduced) biomass; (b) separating the liquid and/or vapor from the solid disintegrated biomass (e.g., biomass with reduced particle size), wherein step (b) may be performed after or in conjunction with step (a); (c) contacting the disintegrated biomass with acid, i.e., acid catalyst, at a concentration sufficient to hydrolyze and/or depolymerize a polymeric carbohydrate component of the biomass, thereby producing acid impregnated disintegrated biomass; and (d) feeding the acid impregnated material into a digestor through a pressure changing device, wherein the acid impregnated material is heated under a second pressure in the digestor at a temperature and for an amount of time sufficient to permit the hydrolysis and/or depolymerization reaction to occur, thereby producing a composition that contains a liquid hydrolysate and residual solids. In some embodiments, the resulting composition or the liquid fraction thereof may be used in a fermentation process, e.g., added to a growth medium for a microbial culture, with or without separation of the liquid hydrolysate from residual solids. Optionally, the method includes (e) separating solids from liquids to produce a liquid hydrolysate and residual solids, wherein the liquid hydrolysate contains soluble hemicellulose sugar molecules and the residual solids contain cellulosic fiber, e.g., partially hydrolyzed cellulosic fiber. In some embodiments, the liquid fraction may be used, e.g., to provide a carbon source, for a microbial fermentation process. In some embodiments, the liquid fraction may be recycled and used for hydrolysis of further biomass and extraction of additional sugar molecules, thereby reducing the amount of acid required for the overall process. In alternate embodiments, liquids and solids are not separated. Optionally, the resulting composition containing liquid hydrolysate and residual solids may be used, for example, in a downstream fermentation process, without separation of liquids from solids.

In some embodiments, step (c) includes contacting the disintegrated biomass with one or more polyol (e.g., glycerol, 1,3-propanediol) and with acid at a concentration sufficient to hydrolyze and/or depolymerize a polymeric carbohydrate component of the biomass, thereby producing acid impregnated disintegrated biomass. The polyol (e.g., glycerol, 1,3-propanediol) may be added separately from acid (e.g., prior to or after acid) or simultaneously with the acid. In some embodiments, glycerol is added at a concentration of about 0.3% (w/w) to about 1.2% (w/w). In one embodiment, biomass is contacted with glycerol (for example, about 0.3% (w/w) glycerol to about 1.2% glycerol (w/w), followed by acid (e.g., about 0.3% (w/w) to about 1.2% (w/w) nitric acid). For example, biomass may be contacted with 0.5% (w/w) acid (e.g., nitric acid) and 0.5% (w/w) glycerol, at a temperature of about 140° C. to about 145° C. for about 40 minutes to about 45 minutes. In one embodiment, the glycerol is added from a raw or crude (unpurified) glycerol composition, for example, glycerol that is a byproduct from biodiesel production. For example, the crude glycerol stream may contain about 60% to about 80% glycerol (w/w).

In some embodiments, the acid, for example, nitric acid, is at a concentration of about 0.7% (w/w) to about 1.5% (w/w), the digestor is operated at a temperature of about 100° C. to about 140° C., about 145° C., about 150° C., about 155° C., or about 160° C. (e.g., about 100° C. to about 160° C.), corresponding to a second pressure of about 0 psig to about 38 psig (about 100° C. to about 140° C.) or about 0 psig to about 75 psig (about 100° C. to about 160° C.), and the residence time in the digestor is about 10 minutes to about 120 minutes. Alternatively, the acid, for example, nitric acid, is at a concentration of about 0.8% to about 1.2% (w/w), the digestor is operated at a temperature of about 110° C. to about 140° C., corresponding to a second pressure of about 6 psig to about 38 psig, and the residence time in the digestor is about 20 minutes to about 90 minutes. Alternatively, the acid, for example, nitric acid, is at a concentration of about 0.9% to about 1.2% (w/w), the digestor is operated at a temperature of about 120° C. to about 130° C., corresponding to a second pressure of about 14 psig to about 24 psig, and the residence time in the digestor is about 45 minutes to about 60 minutes.

In some embodiments of any of the above methods, the liquid and/or vapor that is separated from solid disintegrated biomass in step (b) comprises extractives.

In some embodiments of any of the above methods, mechanical disintegrating, e.g., particle size reduction, is performed in a thermo-mechanical device. The thermo-mechanical device may be selected from, for example, a modular screw device, an oil press, a disc refiner, and a screw press. Mechanical disintegration, e.g., particle size reduction, may be performed at a pressure and residence time sufficient to shear apart the biomass to make it accessible for acid-catalyzed depolymerization of carbohydrate polymers. In some embodiments, the first pressure is about 5 to about 50 psig and the residence time is about 5 psig to about 60 seconds. For example, mechanical disintegration may be performed at a first temperature of about 70° C. to about 100° C., e.g., about 70° C., about 75° C., about 80° C., about 85° C., about 90° C., about 95° C., or about 100° C. In one embodiment, the first temperature is about 85° C. In an embodiment in which the biomass is bagasse, e.g., sugarcane bagasse, mechanical disintegration may serve to remove some extractives and, since the cane juice is acidic, this process may also initiate acid/solid mixing, facilitating acid hydrolysis.

In some embodiments, the digestor is operated under a second temperature of about 100° C. to about 140° C., about 145° C., about 150° C., about 155° C., or about 160° C. (e.g., about 100° C. to about 160° C.), corresponding to a second pressure of about 0 psig to about 38 psig. In some embodiments, the second pressure is higher than the first pressure.

In some embodiments of any of the above methods, the biomass is contacted with steam or other liquids prior to mechanical disintegration, e.g., particle size reduction, which may increase the amount of extractives removed and the degree of disintegration.

In some embodiments, mechanical disintegration of the biomass and associated liquid/solid separation are performed before the acid hydrolysis method, for example, at a separate location, and/or at an earlier time frame prior to contacting the biomass with acid.

In another aspect, a method is provided for deconstructing biomass that contains cellulose and hemicellulose for the extraction of sugar molecules from the biomass, without the mechanical disintegration and separation of liquid from distintegrated biomass, as described above. The method includes: (a) contacting the biomass with acid, i.e., acid catalyst, at a concentration sufficient to hydrolyze and/or depolymerize a polymeric carbohydrate component of the biomass, thereby producing acid impregnated biomass; and (b) feeding the acid impregnated biomass into a digestor through a pressure changing device, wherein the acid impregnated biomass is heated under pressure in said digestor at a temperature and for an amount of time sufficient to permit the hydrolysis and/or depolymerization reaction to occur. In some embodiments, the resulting composition or the liquid fraction thereof may be used in a fermentation process, e.g., added to a growth medium for a microbial culture, with or without separation of the liquid hydrolysate from residual solids. Optionally, the method includes (c) separating solids from liquids to produce a liquid hydrolysate and residual solids, wherein the liquid hydrolysate contains hemicellulose sugar molecules and the residual solids contain cellulosic fiber, e.g., partially hydrolyzed cellulosic fiber. In some embodiments, the liquid fraction may be used, e.g., to provide a carbon source, for a microbial fermentation process. In some embodiments, the liquid fraction may be recycled and used for hydrolysis of further biomass and extraction of additional sugar molecules, thereby reducing the amount of acid required for the overall process. In alternate embodiments, liquids and solids are not separated. Optionally, the resulting composition containing liquid hydrolysate and residual solids may be used, for example, in a downstream fermentation process, without separation of liquids from solids.

In some embodiments, step (a) includes contacting the biomass with one or more polyol (e.g., glycerol, 1,3-propanediol) and with acid at a concentration sufficient to hydrolyze and/or depolymerize a polymeric carbohydrate component of the biomass, thereby producing acid impregnated disintegrated biomass. The polyol (e.g., glycerol, 1,3-propanediol) may be added separately from acid (e.g., prior to or after acid) or simultaneously with the acid. In some embodiments, glycerol is added at a concentration of about 0.3% (w/w) to about 1.2% (w/w). In one embodiment, biomass is contacted with glycerol (for example, about 0.3% glycerol to about 1.2% glycerol (w/w)), followed by acid (e.g., about 0.3% to about 1.2% (w/w) nitric acid). For example, biomass may be contacted with 0.5% (w/w) acid (e.g., nitric acid) and 0.5% (w/w) glycerol, at a temperature of about 140° C. to about 145° C. for about 40 minutes to about 45 minutes. In one embodiment, the glycerol is added from a raw or crude (unpurified) glycerol composition, for example, glycerol that is a byproduct from biodiesel production. For example, the crude glycerol stream may contain about 60% to about 80% glycerol (w/w).

In some embodiments, the acid concentration in step (a) is about 0.7% (w/w) to about 1.5% (w/w), 0.8% (w/w) to about 1.2% (w/w), or about 0.9% (w/w) to about 1.2% (w/w). In some embodiments, the residence time in step (b) is about 10 minutes to about 120 minutes, about 20 minutes to about 90 minutes, or about 45 minutes to about 60 minutes. In some embodiments, the temperature in step (b) is about 100° C. to about 140° C., about 145° C., about 150° C., about 155° C., or about 160° C. (e.g., about 100° C. to about 160° C.), about 110° C. to about 140° C., or about 120° C. to about 130° C. In some embodiments, the acid concentration in step (a) is about 0.7% (w/w) to about 1.5% (w/w), the residence time in step (b) is about 10 minutes to about 120 minutes, and the temperature in step (b) is about 100° C. to about 140° C., corresponding to a pressure of about 0 psig to about 38 psig (about 100° C. to about 140° C.) or about 0 psig to about 75 psig (about 100° C. to about 160° C.). In other embodiments, the acid concentration in step (a) is about 0.8% (w/w) to about 1.2% (w/w), the residence time in step (b) is about 20 minutes to about 90 minutes, and the temperature in step (b) is about 110° C. to about 140° C., corresponding to a pressure of about 6 psig to about 38 psig. In further embodiments, the acid concentration in step (a) is about 0.9% (w/w) to about 1.5% (w/w), the residence time in step (b) is about 45 minutes to about 60 minutes, and the temperature in step (b) is about 120° C. to about 130° C., corresponding to a pressure of about 14 psig to about 24 psig. In some embodiments, the biomass is contacted with steam prior to acid impregnation, which may aid with disintegration of the biomass and extractives removal.

In another aspect, a method is provided for deconstructing and extracting sugar molecules from biomass, including: (a) contacting biomass with acid, glycerol, and water, thereby producing acid impregnated biomass, wherein nitric acid is included at a concentration that is sufficient to hydrolyze and/or depolymerize a polymeric carbohydrate component of the biomass; and (b) feeding the acid impregnated material into a digestor through a pressure changing device, wherein the acid impregnated biomass is heated at a temperature and for a time that is sufficient to produce a composition that comprises a liquid hydrolysate and residual solids, wherein the liquid hydrolysate comprises soluble sugar molecules. In one embodiment, the acid is nitric acid, present at a concentration of about 0.5% (w/w), glycerol is present at a concentration of about 0.5% (w/w), and the acid impregnated material is heated in the digestor at about 140° to about 145° C. for about 40 minutes to about 45 minutes. In one embodiment, the glycerol is contained within and added in a crude glycerol composition that includes about 60% to about 80% glycerol by weight in an amount to provide about 0.5% (w/w) glycerol molecules in the acid hydrolysis mixture that includes nitric acid, glycerol, and water. In one embodiment, the biomass includes bagasse, e.g., sugarcane bagasse.

In another aspect, a method for extracting sugar molecules from biomass is provided, including: (a) contacting biomass with about 0.5% nitric acid (w/w), about 0.5% glycerol (w/w), and water, thereby producing acid impregnated biomass; and (b) feeding the acid impregnated biomass into a digestor through a pressure changing device, wherein the acid impregnated biomass is heated in the digestor at about 140° C. to about 145° C. for about 40 minutes to about 45 minutes, thereby producing a composition that comprises a liquid hydrolysate and residual solids, wherein the liquid hydrolysate comprises soluble sugar molecules. In some embodiments, the glycerol is added in a crude glycerol composition that comprises about 60% to about 80% glycerol by weight. In some embodiments, the biomass is mechanically disintegrated prior to or in conjunction with step (a).

In another embodiment, a method for extracting sugar molecules from biomass is provided, including: (a) contacting a first biomass with acid at a concentration sufficient to depolymerize a polymeric carbohydrate component from the first biomass, thereby producing acid impregnated first biomass; (b) feeding the acid impregnated first biomass into a digestor through a pressure changing device, wherein the acid impregnated first biomass is heated in the digestor at a temperature and for an amount of time sufficient to permit hydrolysis to occur, thereby producing a composition that comprises a first liquid hydrolysate and first residual solids, wherein the first liquid hydrolysate comprises soluble sugar molecules; (c) separating the first liquid hydrolysate from the first residual solids; (d) contacting a second biomass with the first liquid hydrolysate, thereby producing acid impregnated second biomass; and (e) feeding the acid impregnated second biomass into a digestor through a pressure changing device, wherein the acid impregnated second biomass is heated in the digestor at a temperature and for an amount of time sufficient to permit hydrolysis to occur, thereby producing a composition that comprises a second liquid hydrolysate and second residual solids, wherein the second liquid hydrolysate comprises soluble sugar molecules, and wherein the amount of soluble sugar molecules in the second liquid hydrolysate is greater than the amount of soluble sugar molecules in the first liquid hydrolysate. In some embodiments, the first biomass is mechanically disintegrated prior to or in conjunction with step (a). In one embodiment, the acid concentration in step (a) is about 0.7% (w/w) to about 1.5% (w/w), the digestor in step (b) is operated at a temperature of about 100° C. to about 160° C. with a residence time of about 10 minutes to about 120 minutes, and the digestor in step (e) is operated at a temperature of about 100° C. to about 160° C. with a residence time of about 10 minutes to about 120 minutes. In another embodiment, the acid concentration in step (a) is about 0.8% (w/w) to about 1.2% (w/w), the digestor in step (b) is operated at a temperature of about 110° C. to about 140° C. with a residence time of about 20 minutes to about 90 minutes, and the digestor in step (e) is operated at a temperature of about 110° C. to about 140° C. with a residence time of about 20 minutes to about 90 minutes. In a further embodiment, the acid concentration in step (a) is about 0.9% (w/w) to about 1.2% (w/w), the digestor in step (b) is operated at a temperature of about 120° C. to about 130° C. with a residence time of about 45 minutes to about 60 minutes, and the digestor in step (e) is operated at a temperature of about 120° C. to about 130° C. with a residence time of about 45 minutes to about 60 minutes. In some embodiment, the method includes contacting the first biomass with a polyol, wherein the polyol is added separately from the acid in step (a) or simultaneously with the acid in step (a). In one embodiment, the polyol includes glycerol. In some embodiments, glycerol is added in a crude glycerol composition that includes about 60% to about 80% glycerol by weight. In one embodiment, glycerol is included in step (a) at a concentration of about 0.3% (w/w) to about 1.2% (w/w). In one embodiment, the acid in step (a) is nitric acid at a concentration of about 0.3% (w/w) to about 1.2% (w/w). In one embodiment, step (a) comprises contacting the first biomass with about 0.5% (w/w) nitric acid and about 0.5% (w/w) glycerol, wherein the digestor in step (b) is operated at a temperature of about 140° C. to about 145° C. with a residence time of about 40 minutes to about 45 minutes, and wherein the digestor in step (e) is operated at a temperature of about 140° C. to about 145° C. with a residence time of about 40 minutes to about 45 minutes.

In another embodiment, a method for extracting sugar molecules from biomass is provided, comprising: (a) contacting biomass with acid at a concentration of about 0.7% (w/w) to about 1.5% (w/w), thereby producing acid impregnated first biomass; and (b) feeding the acid impregnated first biomass into a digestor through a pressure changing device, wherein the acid impregnated biomass is heated in the digestor at a temperature about 100° C. to about 160° C., and wherein the residence time in the digestor is about 10 minutes to about 120 minutes, thereby producing a composition that comprises soluble sugar molecules. In some embodiments, the composition that comprises soluble sugar molecules comprises a liquid hydrolysate and residual solids, and the method further includes: (c) separating the liquid hydrolysate from the residual solids. In one embodiment, the acid concentration in step (a) is about 0.8% (w/w) to about 1.2% (w/w), wherein the temperature in the digestor in step (b) is about 110° C. to about 140° C., and wherein the residence time in the digestor in step (b) is about 20 minutes to about 90 minutes. In another embodiment, the acid concentration in step (a) is about 0.9% (w/w) to about 1.2% (w/w), wherein the temperature in the digestor in step (b) is about 120° C. to about 130° C., and wherein the residence time in the digestor in step (b) is about 45 minutes to about 60 minutes. In some embodiments, the biomass is mechanically disintegrated prior to or in conjunction with step (a). In some embodiments, the method includes contacting the biomass with a polyol, wherein the polyol is added separately from the acid in step (a) or simultaneously with the acid in step (a). In one embodiment, the polyol includes glycerol. In one embodiment, glycerol is added in a crude glycerol composition that includes about 60% to about 80% glycerol by weight. In one embodiment, the acid concentration in step (a) is about 0.3% (w/w) to about 1.2% (w/w), and wherein glycerol is included in step (a) at a concentration of about 0.3% (w/w) to about 1.2% (w/w).

In some embodiments of any of the above methods, hemicellulose and optionally some cellulose may be depolymerized from the biomass material, and the hydrolysate contains soluble sugar molecules from hemicellulose and optionally some sugar molecules from cellulose.

In some embodiments of any of the above methods, the acid is nitric acid.

In some embodiments of any of the above methods, the pressure changing device in the digestor is selected from a plug screw feeder, a rotary valve, a low pressure feeder, or a lockhopper arrangement. In some embodiments, heating of the acid impregnated biomass (e.g., acid impregnated disintegrated biomass) in the digestor is with direct or indirect steam. In some embodiments of any of the above methods, the digestor is operated under pressure. In one embodiment, the digestor is a continuous feed, pressure rated, screw conveyor vessel. In some embodiments, the material that is fed to the digestor comprises a liquid to solid ratio of about 1:1 to about 20:1. In some embodiments in which a recirculating reactor is used, the liquid to solid ratio may be about 9:1. In embodiments in which a plug flow reactor is used, the liquid to solid ratio may be about 2:1 to about 3:1, or about 2:1 to about 4:1.

In some embodiments of any of the above methods, solids are separated from liquids to produce a hydrolysate and residual solids in a screw press, belt filter press, centrifuge, settling tank, vacuum filter, sieve screen, or rotary drum dryer.

In some embodiments of any of the above methods, the liquid hydrolysate contains about 10 g/l to about 150 g/l, about 40 g/l to about 100 g/l, about 60 g/l to about 90 g/l, or about 65 g/l to about 80 g/l soluble sugar molecules. In some embodiments, the soluble sugar molecules include xylose. In some embodiments, the soluble sugar molecules include mannose, xylose, glucose, arabinose, and galactose.

In some embodiments of any of the above methods, the biomass is lignocellulosic material. In some embodiments, the biomass is selected from softwood and hardwood, or a combination thereof. In one embodiment, the lignocellulosic material is Lodgepole pine. In one embodiment, the lignocellulosic material is in the form of wood chips. In other embodiments of any of the above methods, the biomass is an agricultural residue. In one embodiment, the biomass is bagasse (e.g., sugar cane bagasse).

In another aspect, a liquid hydrolysate or combined liquid and solid hydrolysate composition containing soluble sugars is provided, prepared according to any of the methods above. In some embodiments, the hydrolysate is conditioned to remove one or more inhibitor(s) of microbial growth and/or production of a bioproduct of interest, thereby producing a conditioned hydrolysate. In some embodiments, conditioning is performed by a process selected from overliming, adsorption, precipitation, ion exchange, steam stripping, enzymatic treatment, evaporation, pH adjustment, and filtration, or a combination thereof. In some embodiments, treatment of the hydrolysate to remove inhibitors is not required for the hydrolysate to support the growth of and/or bioproduct production in microbial organisms. In one embodiment, conditioning consists of pH adjustment of the liquid hydrolysate or combined liquid and solid hydrolysate composition to a pH that is suitable for microbial fermentation when the composition is added to a microbial growth medium at a sugar concentration sufficient for growth of the microorganisms. A conditioned hydrolysate, produced as described herein, is also provided.

In another aspect, a method is provided for producing a bioproduct. The method includes culturing a microorganism that produces the bioproduct in a medium that contains a hydrolysate or conditioned hydrolysate (e.g., a liquid hydrolysate or combined liquid and solid hydrolysate composition, with or without conditioning, for example, pH adjustment), prepared as described herein, under conditions suitable for production of the bioproduct. In one embodiment, the bioproduct is a solvent. In some embodiments, the bioproduct is a biofuel, for example, butanol, ethanol, or acetone, or a combination thereof. In some embodiments, the bioproduct is a biochemical or biochemical intermediate, for example, formate, acetate, butyrate, propionate, succinate, methanol, propanol, or hexanol.

### BRIEF DESCRIPTION OF THE DRAWINGS

FIG. 1 is a process flow diagram for an exemplary two stage biomass pretreatment with conditioning.

FIG. 2 is a process flow diagram for an exemplary single stage biomass pretreatment with conditioning.

### DETAILED DESCRIPTION OF THE INVENTION

The invention provides methods for extraction of soluble sugars from biomass material, such as lignocellulosic biomass, by acid hydrolysis. Optionally, the biomass material may be subjected to a disintegration process prior to extraction of soluble sugar molecules. The resulting hydrolysates may be used in downstream microbial fermentation processes for production of bioproducts of interest. The methods described herein include acid impregnation of biomass that contains cellulose and hemicellulose (optionally in the presence of glycerol), digestion of the acid-impregnated biomass material, and separation of a liquid hydrolysate that contains hemicellulose sugar molecules from residual solid material. In other embodiments, the liquid hydrolysate is not separated from residual solid material. In some embodiments, liquid hydrolysate is separated from residual solid material and is recycled for hydrolysis of further biomass. Previous methods in the art for extraction of soluble sugar molecules from biomass require high acid concentrations and high temperatures, resulting in production of inhibitory compounds that interfere with downstream processes such as microbial fermentation to produce bioproducts of interest.

Advantageously, the methods described herein may reduce the impact of extractives on bioproduct, e.g., biofuel, production and process production (i.e., prevents pitch deposits) by reducing or excluding extractives from the hydrolysate produced from a biomass feedstock.

The methods described herein may also advantageously permit hydrolysate to be prepared under less harsh (i.e., reduced severity) process conditions than those described in the art (e.g., reduced acid concentration, reduced temperature, reduced pressure), which serves to minimize production of degradation products that may be inhibitory to downstream processes. In the methods described herein, the temperature for acid hydrolysis of biomass may be kept below or around the glass transition temperature of lignin, minimizing production of phenolic inhibitors generated during the hydrolysis process. The lower acid concentration and reduced temperature (lower steam pressure) may provide a cost benefit and improve yield. The methods described herein may also advantageously provide a higher plant productivity (higher throughput, with associated cost benefit) than other known approaches.

The low severity conditions described herein may reduce production of inhibitors of microbial growth and/or bioproduct production, in comparison to previously reported methods in which harsher conditions are used. In some embodiments of the methods herein, the resulting liquid hydrolysate or combined liquid and solid hydrolysate composition may be used to support growth of a microbial culture without any further processing, such as conditioning processes, prior to addition to the microbial culture. In one embodiment, the pH of the hydrolysate (e.g., liquid hydrolysate or liquid plus residual solids) may be adjusted to a pH that is suitable for growth of the microorganism in the culture, but no other conditioning processes are required to support growth of the culture and/or bioproduct production.

Unless defined otherwise herein, all technical and scientific terms used herein have the same meaning as commonly understood by one of ordinary skill in the art to which this invention belongs. Singleton, et al., Dictionary of Microbiology and Molecular Biology, second ed., John Wiley and Sons, New York (1994), and Hale & Markham, The Harper Collins Dictionary of Biology, Harper Perennial, NY (1991) provide one of skill with a general dictionary of many of the terms used in this invention. Any methods and materials similar or equivalent to those described herein can be used in the practice or testing of the present invention.

The practice of the present invention will employ, unless otherwise indicated, conventional techniques of molecular biology (including recombinant techniques), microbiology, cell biology, and biochemistry, which are within the skill of the art. Such techniques are explained fully in the literature, for example, Molecular Cloning: A Laboratory Manual, second edition (Sambrook et al., 1989); Oligonucleotide Synthesis (M. J. Gait, ed., 1984; Current Protocols in Molecular Biology (F. M. Ausubel et al., eds., 1994); PCR: The Polymerase Chain Reaction (Mullis et al., eds., 1994); and Gene Transfer and Expression: A Laboratory Manual (Kriegler, 1990).

Numeric ranges provided herein are inclusive of the numbers defining the range.

### DEFINITIONS

“A,” “an” and “the” include plural references unless the context clearly dictates otherwise.

“Bioproduct” refers to any substance of interest produced biologically, i.e., via a metabolic pathway, by a microorganism, e.g., in a microbial fermentation process. Bioproducts include, but are not limited to biofuels, solvents, biomolecules (e.g., proteins (e.g., enzymes), polysaccharides), organic acids (e.g., formate, acetate, butyrate, propionate, succinate), alcohols (e.g., methanol, propanol, isopropanol, hexanol, 2-butanol, isobutanol), diols (e.g., 1,3-propanediol), fatty acids, aldehydes, lipids, long chain organic molecules (for example, for use in surfactant production), vitamins, and sugar alcohols (e.g., xylitol).

“Biofuel” refers to fuel molecules (e.g., n-butanol, acetone, ethanol, isobutanol, farnesene, etc.) produced biologically by a microorganism, e.g., in a microbial fermentation process.

“Biobutanol” refers to butanol (i.e., n-butanol) produced biologically by a microorganism, e.g., in a microbial fermentation process.

“Byproduct” refers to a substance that is produced and/or purified and/or isolated during any of the processes described herein, which may have economic or environmental value, but that is not the primary process objective. Nonlimiting examples of byproducts of the processes described herein include lignin compounds and derivatives, carbohydrates and carbohydrate degradation products (e.g., furfural, hydroxymethyl furfural, formic acid), and extractives (described infra).

“Feedstock” refers to a substance that can serve as a source of sugar molecules to support microbial growth in a fermentation process.

“Deconstruction” refers to mechanical, chemical, and/or biological degradation of biomass to render individual components (e.g., cellulose, hemicellulose) more accessible to further pretreatment processes, for example, a process to release monomeric and oligomeric sugar molecules, such as acid hydrolysis.

“Conditioning” refers to removal of inhibitors of microbial growth and/or bioproduct, e.g., biofuel, production from a hydrolysate produced by hydrolysis of a cellulosic feedstock or adjustment of a physical parameter of the hydrolysate to render it more amenable to inclusion in a microbial culture medium, for example, adjustment of the pH to a pH that is suitable for growth of the microorganism when added to a microbial growth medium.

“Titer” refers to amount of a substance produced by a microorganism per unit volume in a microbial fermentation process. For example, biobutanol titer may be expressed as grams of butanol produced per liter of solution.

“Yield” refers to amount of a product produced from a feed material (for example, sugar, relative to the total amount that of the substance that would be produced if all of the feed substance were converted to product. For example, biobutanol yield may be expressed as % of biobutanol produced relative to a theoretical yield if 100% of the feed substance (for example, sugar) were converted to biobutanol.

“Productivity” refers to the amount of a substance produced by a microorganism per unit volume per unit time in a microbial fermentation process. For example, biobutanol productivity may be expressed as grams of butanol produced per liter of solution per hour.

“Wild-type” refers to a microorganism as it occurs in nature.

“Biomass” refers to cellulose- and/or starch-containing raw materials, including but not limited to wood chips, corn stover, rice, grasses, forages, perrie-grass, potatoes, tubers, roots, whole ground corn, grape pomace, cobs, grains, wheat, barley, rye, milo, brans, cereals, sugar-containing raw materials (e.g., molasses, fruit materials, sugar cane, or sugar beets), wood, and plant residues.

“Starch” refers to any starch-containing materials. In particular, the term refers to various plant-based materials, including but not limited to wheat, barley, potato, sweet potato, tapioca, corn, maize, cassava, milo, rye, and brans. In general, the term refers to any material comprised of the complex polysaccharide carbohydrates of plants, comprised of amylose, and amylopectin, with the formula (C₆H₁₀O₅)ₓ, wherein “x” can be any number.

“ABE fermentation” refers to production of acetone, butanol, and/or ethanol by a fermenting microorganism.

“Advanced biofuels” are high-energy liquid transportation fuels derived from low nutrient input/high per acre yield crops, agricultural or forestry waste, or other sustainable biomass feedstocks including algae.

“Lignocellulosic” biomass refers to plant biomass that contains cellulose, hemicellulose, and lignin. The carbohydrate polymers (cellulose and hemicellulose) are tightly bound to lignin.

“Lignins” are macromolecular components of wood that contain phenolic propylbenzene skeletal units linked at various sites.

“Solvent” refers to a liquid or gas produced by a microorganism that is capable of dissolving a solid or another liquid or gas. Nonlimiting examples of solvents produced by microorganisms include n-butanol, acetone, ethanol, acetic acid, isopropanol, n-propanol, methanol, formic acid, 1,4-dioxane, tetrahydrofuran, acetonitrile, dimethylformamide, and dimethyl sulfoxide.

A “protic” solvent contains dissociable H⁺, for example a hydrogen atom bound to an oxygen atom as in a hydroxyl group or a nitrogen atom as in an amino group. A protic solvent is capable of donating a proton (H⁺). Conversely, an “aprotic” solvent cannot donate H⁺.

n-Butanol is also referred to as “butanol” herein.

“Direct steam” refers to steam that is added into a process stream.

“Indirect steam” refers to steam that is not in direct contact with a process fluid, for example, steam that is injected into a jacket or heat exchanger.

“ATCC” refers to the American Type Culture Collection, P.O. Box 1549, Manassas, Va. 20108.

### Feedstock

A feedstock is a substance that provides the base material from which sugar molecules are generated for inclusion in a microbial growth medium, to support the growth of the microorganism. Feedstock used in the methods described herein contains cellulose and hemicellulose. For example, the feedstock may be lignocellulosic biomass or wood pulp, or bagasse, e.g., sugarcane bagasse. In some embodiments, an amount of feedstock that is used in a method disclosed herein is calculated as dry weight of biomass.

Cellulose, which is a β-glucan built up of D-glucose units linked by β(1,4)-glycosidic bonds, is the main structural component of plant cell walls and typically constitutes about 35-60% by weight (% w/w) of lignocellulosic materials.

Hemicellulose refers to non-cellulosic polysaccharides associated with cellulose in plant tissues. Hemicellulose frequently constitutes about 20-35% w/w of lignocellulosic materials, and the majority of hemicelluloses consist of polymers based on pentose (five-carbon) sugar units, such as D-xylose and D-arabinose units, hexose (six-carbon) sugar units, such as D-glucose and D-mannose units, and uronic acids such as D-glucuronic acid.

Lignin, which is a complex, cross-linked polymer based on variously substituted p-hydroxyphenylpropane units, typically constitutes about 10-30% w/w of lignocellulosic materials.

Any material containing cellulose and hemicellulose may be used as the feedstock. The material may contain cellulose and hemicellulose with or without lignin.

In some embodiments, the feedstock is woody biomass. In one embodiment, the feedstock is softwood, for example, pine, e.g., Lodgepole or Loblolly pine. In one embodiment, the feedstock contains mountain pine beetle infested pine, for example, dying (“red stage”) or dead (“grey” stage) pine. In another embodiment, the feedstock is hardwood, for example, maple, birch, or ash. In another embodiment, the feedstock is mixed hardwood and softwood. In another embodiment, the feedstock is mixed hardwood. In some embodiments, the woody biomass is in the form of wood chips, sawdust, saw mill residue, wood fines, or a combination thereof.

In some embodiments, the feedstock is obtained as a process stream from a biomass processing facility, for example, a pulp mill. In various embodiments of pulp mill process streams, the process stream may include reject pulp, wood knots or shives, pulp screening room rejects (e.g., essentially cellulose in water), prehydrolysis extraction stream, and/or black liquor.

In some embodiments, the feedstock is an agricultural residue. For example, bagasse may be used as the feedstock. Bagasse is the residual fiber generated as part of the sugar extraction process from sugarcane or sorghum, for example, in a sugar mill or biorefinery. Bagasse contains hemicellulose, cellulose, lignin, and some residual sugars. In some embodiments, bagasse may contain residual sucrose that was not removed during sugarcane processing. Residual sucrose may be extracted along with hemicellulose sugars in a method disclosed herein and during acid hydrolysis, the sucrose may be hydrolyzed to glucose and fructose, which will be included in the soluble sugar molecules in the hydrolysate, in addition to sugar molecules extracted from hemicellulose and cellulose carbohydrate polymers.

Lignocellulose contains a mixture of carbohydrate polymers and non-carbohydrate compounds. The carbohydrate polymers contain cellulose and hemicellulose, and the non-carbohydrate portion contains lignin. The non-carbohydrate portion may also contain ash, extractives, and/or other components such as proteins. The specific amounts of cellulose, hemicellulose, and lignin depend on the source of the biomass.

In some embodiments, the feedstock is a lignocellulosic material in the form of wood chips, sawdust, saw mill residue, or a combination thereof. In some embodiments, the lignocellulosic material is from a feedstock source that has been subjected to some form of disease in the growth and/or harvest production period. In one embodiment, the feedstock source is mountain pine beetle infested pine. In another embodiment, the feedstock source is sudden oak death syndrome infested oak, e.g., coastal live oak, tanoak, etc. In another embodiment, the feedstock source is Dutch elm disease infested elm. In other embodiments, the feedstock source is lignocellulosic material that has been damaged by drought or fire.

Lignocellulosic biomass may be derived from a fibrous biological material such as wood or fibrous plants. Examples of suitable types of wood include, but are not limited to, spruce, pine, hemlock, fir, birch, aspen, maple, poplar, alder, salix, cottonwood, rubber tree, marantii, eucalyptus, sugi, and acase. Examples of suitable fibrous plants include, but are not limited to, corn stover and fiber, flax, hemp, cannabis, sisal hemp, bagasse, straw, cereal straws, reed, bamboo, mischantus, kenaf, canary reed, Phalaris arundinacea, and grasses. Other lignocellulosic materials may be used such as herbaceous material, agricultural crop or plant residue, forestry residue, municipal solid waste, pulp or paper mill residue, waste paper, recycling paper, or construction debris. Examples of suitable plant residues include, but are not limited to, stems, leaves, hulls, husks, cobs, branches, bagasse, cane trash, wood chips, wood pulp, wood pulp, and sawdust. Aquatic plants such as kelp, algae, lily, and hyacinth which contain proportionately higher levels of hemicellulose can also be used.

In some embodiments, a feedstock mix containing about 40% logging residues, about 20% sustainable roundwood, about 20% woody energy crops, and about 20% herbaceous energy crops may be used. This blend can account for regional variation and provide significant flexibility in selecting locations for facilities and in procuring feedstock supply contracts.

In some embodiments, the feedstock contains grass, for example, sugar cane, miscanthus, and/or switchgrass, and/or straw, for example, wheat straw, barley straw, and/or rice straw.

### Methods for Deconstruction of Biomass and Extraction of Hemicellulose Sugar Molecules

Methods are provided herein for deconstruction of feedstock to extract soluble sugar molecules from hemicellulose and optionally cellulose. The methods herein include acid impregnation of biomass that contains cellulose and hemicellulose, digestion of the acid impregnated material, and optional separation of liquid hydrolysate which contains soluble hemicellulose sugars from residual solid material. Optionally, the method may include mechanical disintegration of the biomass prior to acid impregnation. Optionally, the method may include removal of extractives in conjunction with mechanical disintegration or between mechanical disintegration and acid impregnation of the biomass. In one embodiment in which bagasse is used as the feedstock, extractives may be removed (e.g., partially removed) during the sugar extraction process from sugarcane or sorghum.

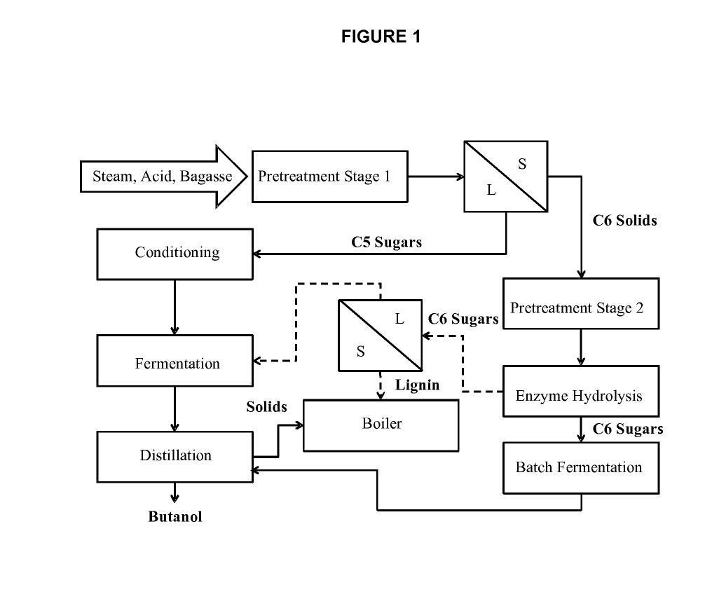

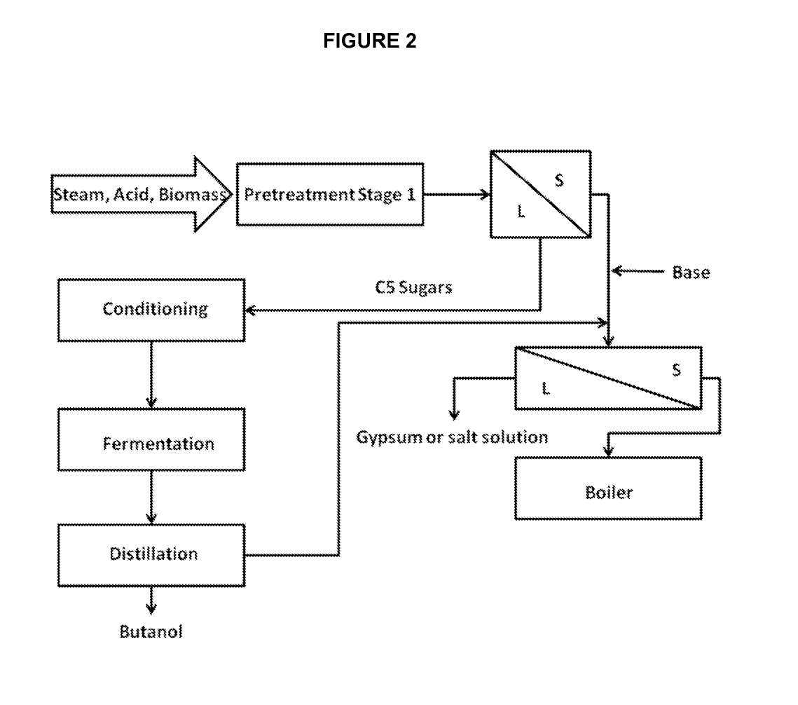

Examples of process flow diagrams for two stage and single stage biomass pretreatment processes and downstream bioproduct (e.g., butanol) production and purification processes are shown schematically in FIGS. 1 and 2. These figures do not show optional biomass size reduction or handling that may occur prior to acid hydrolysis (“Pretreatment Stage 1”). Depending on the nature of the biomass, method of harvest, and/or storage conditions, the biomass may or may not require size reduction (for example, grinding) and/or other processing prior to hydrolysis.

In some embodiments, Pretreatment Stage 1 may include a steaming step to preheat the biomass to remove air from the material and open the structure for acid impregnation. Such a steaming step may also provide crude washing of the biomass by removing condensate from the containing (e.g., steaming) bin in which the steaming takes place.

Another approach (no figure provided) would be to perform the hydrolysis and pass the sugars and residual solids (e.g., the entire stream) to fermentation and on to distillation. The solids could be removed either before or after product purification, e.g., distillation. This approach may result in more effective sugar recovery and utilization.

The production of hemicellulosic sugars in Stage 1 pretreatment using previously disclosed methods in the art typically produces a sugar stream laden with inhibitors, including but not limited to acetic acid, furfural, hydroxymethyl furfural (HMF), and numerous phenolic inhibitors that act as antimicrobial compounds, including syringic acid, guaiacol, etc. Production of such inhibitory compounds (and in some embodiments, the requirement for further processing steps to remove or minimize inhibitors prior to inclusion of hydrolysate compositions in microbial fermentations) is minimized in the methods disclosed herein by performing the biomass pretreatment (e.g., Pretreatment Stage 1) with lower severity conditions. The severity of the pretreatment is lowered by using significantly lower Stage 1 temperatures. Lower reactor temperatures also reduce the steam pressure and in turn the design requirements (pressure) of the reactor, thereby reducing overall reactor cost and associated ancillary equipment.

The use of the lower pretreatment temperatures and acid concentrations will lead to less toxic sugar streams (e.g., less toxic xylose sugar streams) from Stage 1 pretreatment. In embodiments in which a two stage hydrolysis system is used, the use of the lowest possible severity conditions for steam explosion during Stage 2 pretreatment may also lead to reduced inhibitor levels for enzyme hydrolysis and fermentation.

In some embodiments of the disclosed methods herein, the resulting hydrolysate product, with lower concentrations and/or inhibitory activity of inhibitor compounds, advantageously is more fermentable by a microorganism, for example, a bacterial microorganism, such as a Clostridium strain, in comparison a hydrolysate produced under identical conditions except the acid concentration, and time and temperature (and pressure) in the digestor, as disclosed herein.

For example, a method is provided for deconstructing biomass that contains cellulose and hemicellulose for the extraction of sugar molecules from the biomass, including: (a) contacting the biomass with acid (i.e., acid catalyst) at a concentration sufficient to hydrolyze and/or depolymerize a polymeric carbohydrate component of the biomass, thereby producing acid impregnated biomass; and (b) feeding the acid impregnated biomass into a digestor through a pressure changing device, wherein the acid impregnated biomass is heated under pressure in said digestor at a temperature and for an amount of time sufficient to permit the hydrolysis and/or depolymerization reaction to occur, thereby producing a hydrolysate composition that contains liquid hydrolysate with soluble sugar molecules and residual solids. This composition may be added to a microbial culture medium to support growth of microorganisms and/or bioproduct production, or the liquid hydrolysate may be separated from the residual solids and the liquid hydrolysate added to the culture medium (e.g., after pH adjustment to an appropriate pH for the growth of the microbial culture). Optionally, the method further includes (c) separating solids from liquids to produce a liquid hydrolysate and residual solids, wherein the liquid hydrolysate contains hemicellulose sugar molecules. Optionally, step (a) may be performed in the presence of a polyol such as glycerol.

In one embodiment, the method includes (a) mechanically disintegrating (e.g., reducing the particle size of) the biomass in the presence of water and under a first pressure, thereby producing liquid and/or vapor and solid disintegrated biomass; (b) separating liquid and/or vapor from the biomass after or in conjunction with step (a); (c) contacting the disintegrated (e.g., particle size reduced) biomass with acid, i.e., acid catalyst, in an amount sufficient to hydrolyze and/or depolymerize one or more polymeric carbohydrate component(s) (e.g., hemicellulose and optionally some cellulose) of the biomass, thereby producing acid impregnated disintegrated biomass; and (d) feeding the acid impregnated disintegrated biomass into a digestor through a pressure changing device, with the impregnated disintegrated biomass heated under a second pressure in the digestor at a temperature and for an amount of time sufficient to permit the hydrolysis and/or depolymerization reaction to occur, thereby producing a hydrolysate composition that contains liquid hydrolysate with soluble sugar molecules and residual solids. This composition may be added to a microbial culture medium to support growth of microorganisms and/or bioproduct production, or the liquid hydrolysate may be separated from the residual solids and the liquid hydrolysate added to the culture medium (e.g., after pH adjustment to an appropriate pH for the growth of the microbial culture). Optionally, the method further includes (e) separating solids from liquids to produce a liquid hydrolysate and residual solids, wherein the liquid hydrolysate contains hemicellulose sugar molecules. Optionally, step (c) is performed in the presence of glycerol.

The acid concentration, residence time in the digestor, temperature in the digestor, and/or pressure in the digestor may be adjusted to produce residual solid material with desired structural properties (e.g., retention or destruction of cellulose fiber). In some embodiments, the residual solid material contains cellulose fiber (e.g., partially hydrolyzed cellulose fiber), for example, with a length weighted average length of about 0.05 mm to about 1 mm, about 0.1 mm to about 0.5 mm, about 0.2 mm to about 0.4 mm, or about 0.3 mm to about 0.35 mm. The resulting fiber mean length can be controlled by the degree of hydrolysis as well as the severity of the depressurization. For example, water or other material may be added before the depressurization event to minimize fiber damage and/or disruption.

In the methods described herein, the acid concentration (for example, nitric acid) may be about 0.7% (w/w) to about 1.5% (w/w), or alternatively, about 0.8% (w/w) to about 1.2% (w/w) or about 0.9% (w/w) to about 1.2% (w/w), about 0.4% (w/w) to about 0.6% (w/w), or about 0.3% (w/w) to about 0.7% (w/w). In various embodiments, the acid concentration (for example, nitric acid) may be any of about 0.3%, 0.4%, 0.5%, 0.6%, 0.7%, 0.8%, 0.9%, 1.0%, 1.1%, 1.2%, 1.3%, 1.4%, or 1.5% (w/w).

In the methods described herein, the temperature in the digestor may be about 100° C. to about 140° C., about 100° C. to about 160° C., or alternatively, about 110° C. to about 140° C. or about 120° C. to about 130° C. In various embodiments, the temperature in the digestor may be any of about 100, 105, 110, 115, 120, 125, 130, 135, 140, 145, 150, 155, or 160° C.

In the methods described herein, the residence time in the digestor may be about 10 minutes to about 120 minutes, or alternatively, about 20 minutes to about 90 minutes or about 45 minutes to about 60 minutes. In various embodiments, the residence time in the digestor may any of about 10, 15, 20, 25, 30, 35, 40, 45, 50, 55, 60, 65, 70, 75, 80, 85, 90, 95, 100, 110, 115, or 120 minutes.

In one example, the acid concentration (for example, nitric acid) is about 0.7% (w/w) to about 1.5% (w/w), the temperature in the digestor is about 100° C. to about 140° C., and the residence time in the digestor is about 10 minutes to about 120 minutes. In another example, the acid concentration (for example, nitric acid) is about 0.8% (w/w) to about 1.2% (w/w), the temperature in the digestor is about 110° C. to about 140° C., and the residence time in the digestor is about 20 minutes to about 90 minutes. In a further example, the acid concentration (for example, nitric acid) is about 0.9% (w/w) to about 1.2% (w/w), the temperature in the digestor is about 120° C. to about 130° C., and the residence time in the digestor is about 45 minutes to about 60 minutes.

In embodiments in which acid hydrolysis is performed in the presence of glycerol, the glycerol concentration may be, for example, about 0.3% (w/w) to about 1.2% (w/w). In one embodiment, biomass is contacted with glycerol (for example, about 0.3% (w/w) glycerol to about 1.2% glycerol (w/w)), followed by acid (e.g., about 0.3% (w/w) to about 1.2% (w/w) nitric acid). For example, biomass may be contacted with 0.5% (w/w) acid (e.g., nitric acid) and 0.5% glycerol (w/w), at a temperature of about 140° C. to about 145° C. for about 40 minutes to about 45 minutes.

Optional separation of the liquid hydrolysate from residual solids may be performed in equipment that is capable of pressing the liquid hydrolysate from the solids, for example, a screw press or roller mill.

Liquid hydrolysates prepared as described herein may contain pentose and hexose sugars in relative amounts that are substantially consistent with the composition of hemicellulose and cellulose sugars that are accessible and hydrolysable in the hydrolysis process. In some embodiments, the liquid hydrolysate may contain pentose sugars and a small amount of hexose sugars, from hydrolysis of the hemicellulose component of the biomass, for example, in certain hydrolysates prepared from bagasse.

Optionally, a liquid hydrolysate prepared as described herein may be recycled for hydrolysis of further biomass, thereby reducing the amount of acid used in the overall process.

Residual solids that contain cellulose and lignin may optionally be washed, dewatered, and burned to produce energy for other processes, such as fermentation of the hydrolysate and/or purification of a bioproduct from the fermentation, and/or pretreatment (e.g., hydrolysis) of further biomass.

In some embodiments, cellulose in the residual solids is hydrolyzed (for example, “Pretreatment Stage 2” as shown in FIG. 1), for example, via acid or enzymatic hydrolysis. Enzymatic hydrolysis may include, for example, simultaneous saccharification and fermentation (SSF), separate hydrolysis and fermentation (SHF), or a hybrid saccharification and fermentation (HSF). After removal of the cellulose, residual lignin may be used as an energy source for other processes, as described above.

Prior to hydrolysis in the methods described herein, biomass may be obtained, for example, from a forestry company, local farmer, sugar cane mill (bagasse), etc. In some embodiments, the material may require particle size reduction prior to deconstruction and hydrolysis as described herein. For example, particle size reduction may be performed in a shredder or hammermill to a nominal screen size of 3 inches, although larger and smaller screen sizes may also be used. Larger screen sizes may require an evaluation of openings in downstream processes to make sure the material will pass through all openings or bridging and/or plugging may occur. Smaller particle sizes may require more energy to make, for example, the grinder/shredder may have to work harder to break the material down to the small size.

Moisture level of the biomass may be measured, for example, with a halogen lamp based moisture balance or in an oven set at 45° C. or 50° C. to constant weight, for example, in order to better define the liquid to solids ratio in the digestor. The water added to the hydrolysis or pretreatment (e.g., deconstruction) may be adjusted to account for the variable amount of water (as moisture) contained in the biomass.

The biomass may be titrated to measure its buffering capacity. The amount of acid added may be increased accordingly to account for buffering capacity. The same analysis may apply to water used for the pretreatment process. For example, some local water systems contain water softened, for example, with lime, which results in softened water, for example, with a pH of about 9 to about 9.5, causing the acid to be partially neutralized or buffered prior to the pretreatment process described herein.

In some embodiments of the methods disclosed herein, acid (e.g., nitric acid) and water may be added to biomass in a steaming bin or similar device that facilitates good mixing of the acid, water, and biomass. Steam may be used to preheat and remove or replace air in the interstices of the biomass material. The steam may preheat the material to about 100° C., followed by conveyance of the material into the main pretreatment reactor or digestor (e.g., “Pretreatment Stage 1”).

Acid (e.g., nitric acid) may be added in an amount sufficient to reach the acid concentration ranges described above (e.g., about 0.7% (w/w) to about 1.5% (w/w), about 0.8% (w/w) to about 1.2% (w/w), or about 0.9% (w/w) to about 1.2% (w/w)). This concentration may be increased depending on the buffering capacity of the biomass and the starting pH of the water being used for the pretreatment. The liquid to solids ratio used during the pretreatment may be dependent on the reactor type and the ability of a particular reactor to handle high or low solids. For example, for recirculating reactors, the liquid to solids ratio may be about 9:1, and for plug flow reactors, the liquid to solids ratio may be about 2:1 to about 3:1. The solids level may directly relate to the sugar titer produced in the pretreatment process, while maintaining the same overall sugar yield. The solids loading is directly related to the final sugar titer. For instance, the expected sugar titer for 10 percent solids or liquid to solids ratio of 9:1 is about 3%. In contrast a 30% solids level might be expected to produce a sugar titer of 7 to 10% sugar due to the higher level of solids in the reaction.

In some embodiments, at least a portion of the acid (e.g., nitric acid) may be recycled, for example, by flashing the material as it comes out of the reactor and condensing the flash products. The acid can also be recycled, for example, by steam distillation. Acid (e.g., nitric acid) recovery would allow for the usage of higher concentrations of acid, and lower overall production costs by preventing the loss of material. Several acid (e.g., nitric acid) recovery technologies exist, including but not limited to, steam stripping distillation, azeotropic distillation (the addition of another compound to affect the properties of the mixture), liquid-liquid extraction, membrane separation, ion exchange, and or chromatography.

Nitric acid and water form a maximum boiling or negative azeotrope with a maximum boiling temperature of the mixture being about 120° C. at atmospheric pressure. This point corresponds to about 67% HNO₃. Liquid mixtures more dilute than this, when boiled, have a vapor phase that contains less HNO₃ than the liquid phase. In effect, multiple boiling and condensation processes, such as those that occur in a distillation column, may be used to concentrate the HNO₃ solution for reuse. A similar approach could be envisioned for other carboxylic and mineral acids with low boiling points compatible with the temperature ranges of the pretreatment methods disclosed herein (e.g., about 100° C. to about 140° C.), such as formic acid, acetic acid, propionic acid, phosphoric acid, or hydrochloric acid (HCl)

The methods described herein are applicable, for example, to agricultural residues, including but not limited to, sugar cane bagasse, grasses, corn stover, corn cobs, wheat straw, barley straw, oat straw, triticale straw, and soybean straw. The process is also applicable, for example, to forestry residues, forestry related pulp woods, energy woods and/or cane.

### Deconstruction

Optionally, biomass may be deconstructed prior to acid impregnation. For example, such deconstruction may serve to increase the accessibility of the biomass to the acid. Deconstruction may occur in conjunction with, i.e., at the same location and just prior to or close in time, to the hydrolysis process disclosed herein. Alternatively, deconstruction may occur at the same or separate location and earlier in time (e.g., days, weeks, months, years) prior to acid hydrolysis. In some embodiments in which bagasse is used as the biomass, mechanical deconstruction may occur during the sugar extraction process as sugar is extracted from sugarcane or sorghum.

Deconstruction may include mechanical disintegration in the presence of water and under pressure, thereby producing liquid and/or vapor and solid disintegrated biomass. In some embodiments, mechanical disintegration may be performed at a pressure and residence time sufficient to shear apart the biomass to render the carbohydrate polymers therein more accessible for acid-catalyzed depolymerization.

In some embodiments, mechanical disintegration may include particle size reduction of the biomass.

In some embodiments, mechanical disintegration is performed in a thermo-mechanical disintegrator. Non-limiting examples of thermo-mechanical disintegrators that may be used in the methods herein include modular screw devices, oil presses, and screw presses.

Mechanical disintegration, e.g., particle size reduction, in the methods herein is typically performed under pressure, for example, a pressure of about 5 to about 50 psig. In some embodiments, the residence time in the disintegrator is about 5 to about 60 seconds.

### Removal of Extractives

Optionally, extractives may be removed simultaneously with or after mechanical disintegration of the biomass. Extractives are compounds that may be separated in a liquid or vapor phase from the solid disintegrated biomass, and may be inhibitory to a downstream process such as microbial fermentation if present in the biomass hydrolysate.

Removal of extractives may occur in conjunction with, i.e., at the same location and just prior to or close in time, to the hydrolysis process disclosed herein. Alternatively, removal of extractives may occur at the same or separate location and earlier in time (e.g., days, weeks, months, years) prior to acid hydrolysis. In some embodiments in which bagasse is used as the biomass, some portion of extractives may be removed during the sugar extraction process as sugar is extracted from sugarcane or sorghum.

Non-limiting examples of extractives include terpenes, resin acids, fatty acids, sterols, phenolic compounds, and triglycerides. Extractives may include, but are not limited to, p-coumaric acid, ferulic acid, 4-hydroxybenzoic acid, vanillic acid, syringaldehyde, vanillin, furfural, hydroxymethylfurfural, glucuronic acid, acetic acid, and methanol. Extractives may be removed for other uses, such as production of sterols, or burned to provide energy for a bioproduct production process as described herein.

In some embodiments, mechanical disintegration of the biomass is performed in the presence of water, and extractives are removed when liquid or vapor is separated from the biomass, either during or after the disintegration process. In some embodiments, acetic acid, methanol, and/or terpenes are removed in the vapor phase. In some embodiments, resin acids are removed in the liquid phase.

### Acid Impregnation

The biomass feedstock contains sugar molecules in an oligomeric form, e.g., a polymeric form, which must be hydrolyzed to extract and release soluble monomeric and/or multimeric sugar molecules. The soluble sugar molecules may be converted to bioproduct, in a microbial fermentation as described herein.

In the methods described herein, depolymerization of biomass sugar polymers is catalyzed by acid. The biomass is contacted with acid at a concentration sufficient to depolymerize a polymeric component of the biomass. For example, an acid concentration may be used that is sufficient to depolymerize hemicellulose, and optionally some cellulose. In some embodiments, the biomass is mechanically disintegrated, as described above, prior to contact with acid.

Acids that may be used for hydrolysis include, but are not limited to, nitric acid, formic acid, acetic acid, phosphoric acid, hydrochloric acid, and sulfuric acid, or a combination thereof. Examples of acid concentrations that may be used in this process are described above, and may be adjusted depending on the desired structure of the product (i.e., length of resulting cellulosic fiber). In some embodiments, nitric acid is used in any of the hydrolysis methods described herein.

In some embodiments, one or more polyol (e.g., glycerol; 1,3-propanediol) is included with acid for acid impregnation of biomass. The polyol(s) may be added to biomass separately (before or after) the acid or simultaneously with the acid.

### Production of Hydrolysate

The acid-impregnated biomass material is fed into a digestor through a pressure changing device. The material is heated in the digestor at a temperature and for an amount of time sufficient for depolymerization of the carbohydrate polymers, i.e., hemicellulose, to occur. Solids are then optionally separated from liquids to produce a liquid hydrolysate and residual solids.

Nonlimiting examples of pressure changing devices that may be used for feeding acid impregnated biomass into a digestor in the methods described herein include plug screw feeders, rotary valves, or lockhopper arrangements. In one embodiment, the acid impregnated biomass material is heated in the digestor with direct steam. In another embodiment, the acid impregnated biomass material is heated in the digestor with indirect steam.

In some embodiments, the digestor is operated under pressure. In one embodiment, the digestor is a continuous feed, pressure rated, screw conveyor vessel.

In some embodiments, acid impregnated biomass material is fed to the digestor at a liquid to solid ratio of about 1:1 to about 20:1.

At commercial scale, about 100 to about 15,000 ODMT (oven dry metric tonnes) of acid impregnated feedstock may be fed to the digestor per day.

The conditions in the digestor may be adjusted to produce a residual solid product with desired structural characteristics (i.e., length of resulting cellulosic fiber).

In the methods described herein, the acid concentration (for example, nitric acid) may be about 0.7% (w/w) to about 1.5% (w/w), or alternatively, about 0.8% (w/w) to about 1.2% (w/w) or about 0.9% (w/w) to about 1.2% (w/w), about 0.4% (w/w) to about 0.6% (w/w), or about 0.3% (w/w) to about 0.7% (w/w). In various embodiments, the acid concentration (for example, nitric acid) may be any of about 0.3%, 0.4%, 0.5%, 0.6%, 0.7%, 0.8%, 0.9%, 1.0%, 1.1%, 1.2%, 1.3%, 1.4%, or 1.5% (w/w).

In the methods described herein, the temperature in the digestor may be about 100° C. to about 140° C., about 145° C., about 150° C., about 155° C., or about 160° C. (e.g., about 100° C. to about 160° C.), or alternatively, about 110° C. to about 140° C. or about 120° C. to about 130° C. In various embodiments, the temperature in the digestor may be any of about 100, 105, 110, 115, 120, 125, 130, 135, 140, 145, 150, 155, or 160° C.

In the methods described herein, the residence time in the digestor may be about 10 minutes to about 120 minutes, or alternatively, about 20 minutes to about 90 minutes or about 45 minutes to about 60 minutes. In various embodiments, the residence time in the digestor may any of about 10, 15, 20, 25, 30, 35, 40, 45, 50, 55, 60, 65, 70, 75, 80, 85, 90, 95, 100, 110, 115, or 120 minutes.

In one example, the acid concentration (for example, nitric acid) is about 0.7% (w/w) to about 1.5% (w/w), the temperature in the digestor is about 100° C. to about 140° C., and the residence time in the digestor is about 10 minutes to about 120 minutes. In another example, the acid concentration (for example, nitric acid) is about 0.8% (w/w) to about 1.2% (w/w), the temperature in the digestor is about 110° C. to about 140° C., and the residence time in the digestor is about 20 minutes to about 90 minutes. In a further example, the acid concentration (for example, nitric acid) is about 0.9% (w/w) to about 1.2% (w/w), the temperature in the digestor is about 120° C. to about 130° C., and the residence time in the digestor is about 45 minutes to about 60 minutes.

In embodiments in which acid hydrolysis is performed in the presence of glycerol, the glycerol concentration may be, for example, about 0.3% (w/w) to about 1.2% (w/w). In one embodiment, biomass is contacted with glycerol (for example, about 0.3% (w/w) glycerol to about 1.2% glycerol (w/w)), followed by acid (e.g., about 0.3% (w/w) to about 1.2% (w/w) nitric acid). For example, biomass may be contacted with 0.5% (w/w) acid (e.g., nitric acid) and 0.5% glycerol (w/w), at a temperature of about 140° C. to about 145° C. for about 40 minutes to about 45 minutes.

After the digestion process, solids may optionally be separated from liquids. Nonlimiting examples of methods for such separation include a screw press, roller mill, belt filter press, centrifuge, settling tank, vacuum filter, or rotary drum dryer. Alternatively, the composition containing liquids and solid residues may be used in a downstream process, e.g., microbial fermentation, without separation.

The liquid hydrolysate typically contains about 10 to about 150 g/l, about 40 g/l to about 100 g/l, about 60 g/l to about 90 g/l, or about 65 g/l to about 80 g/l sugar molecules (e.g., hemicellulose sugar molecules) depending on the amount of moisture in the feed and the water added. For example, the hydrolysate may contain mannose, xylose, glucose, arabinose, and/or galactose. In some embodiments, some depolymerization of the cellulose portion may also occur, for example, up to about 5% or about 10%.

In some embodiments, % solids discharged from the digestor is about 15% (w/w) to about 25% (w/w) relative to total mass of discharged material (for example, mass of solids in the discharge divided by (mass of water in feed+solubilized solids+condensed steam)).

### Conditioning of Hydrolyzed Feedstock

In some embodiments, hydrolysate, produced as described herein is “conditioned” to remove inhibitors of microbial growth and/or bioproduct, production and/or to adjust one or more parameters of the hydrolysate to render it more suitable for addition to a microbial growth medium, for example, adjustment of pH and/or temperature to a physiologically acceptable level for growth of a microorganism when added to microbial growth medium.

In some embodiments of the methods disclosed herein, the low severity conditions employed render the hydrolysate fermentable, i.e., suitable for microbial fermentation, after raising the pH to a physiologically acceptable level for growth of a particular microbial culture, for example, from about pH 2.5 to about pH 6 to 7 (e.g., about 6.7). In some embodiments, no further conditioning processes are required, other than the pH adjustment, for the hydrolysate to support microbial growth and/or bioproduct production (i.e., treatment of the hydrolysate to remove inhibitors is not required). Although not wishing to be bound by theory, raising the pH may result in deprotonation of certain organic acid inhibitor compounds, rendering them less inhibitory.

In some embodiments, conditioning processes are included for removal of inhibitors from the hydrolysate. Inhibitors of microbial growth and/or bioproduct production may include, but are not limited to, organic acids, furans, phenols, soluble lignocellulosic materials, extractives, and ketones. Inhibitors present in wood hydrolysates may include, but are not limited to, 5-hydroxyy-methyl furfural (HMF), furfural, aliphatic acids, levulinic acid, acetic acid, formic acid, phenolic compounds, vanillin, dihydroconiferylalcohol, coniferyl aldehyde, vanillic acid, hydroquinone, catechol, acetoguaiacone, homovanillic acid, 4-hydroxy-benzoic acid, Hibbert's ketones, ammonium nitrate and/or other salts, p-coumaric acid, ferulic acid, vanillic acid, syringaldehyde, sinapyl alcohol, and glucuronic acid.

Nonlimiting examples of conditioning processes for removal of inhibitors include vacuum or thermal evaporation, overliming, precipitation, adsorption, enzymatic conditioning (e.g., peroxidase, laccase), chemical conversion, distillation, evaporation, filtration, and ion exchange, or a combination thereof. In one embodiment, conditioning includes contact of hydrolyzed feedstock with an ion exchange resin, such as an anion or cation exchange resin. Inhibitors may be retained on the resin. In one embodiment, the ion exchange resin is an anion exchange resin. Ion exchange resins may be regenerated with caustic, some solvents, potentially including those generated in the bioproduct, e.g., biofuel, production processes described herein, or other known industrial materials. In other embodiments, inhibitors may be precipitated by a metal salt (for example, a trivalent metal salt, for example, an aluminum or iron salt, such as aluminum sulfate or ferric chloride), calcium based salts (for example, lime) and/or a flocculant such as polyethylene oxide or other low density, high molecular weight polymers.

In one embodiment, hydrolysate is conditioned on ion exchange resin, such as an anion exchange resin, e.g., Duolite A7, at acidic pH, for example, pH about 2.5 to about 5.5, about 3.5 to about 4.5, or about 2.5, 3, 3.5, 4, 4.5, 5, or 5.5.

In one embodiment, hydrolysate is conditioned with calcium oxide or hydroxide (lime). In some embodiments, the lime is added to increase the pH of the hydrolysate to about 12, about 11, or about 10, at a temperature of about 30° C. to about 60° C., for about 30 minutes to about 60 minutes or about 40 minutes to about 50 minutes, or up to about 72 hours. The resulting precipitation process removes calcium salts and condensable lignins and phenolic compounds, rendering the resulting hydrolysate more fermentable.

In one embodiment, hydrolysate is conditioned with a metal salt, for example, a trivalent metal salt, such as an aluminum or iron salt, e.g., aluminum sulfate or ferric chloride. In some embodiments, the metal salt is added at a concentration of about 1 g/L to about 6 g/L, or about 3 g/L to about 5 g/L. In some embodiments, the pH is adjusted with a base to a basic pH, such as about 9.5 to about 11, or about 9.5, 10, 10.5, or 11, for example, with ammonium hydroxide or ammonia gas.

In some embodiments, microbial growth and/or bioproduct, e.g., biofuel, titer, yield, and/or productivity is increased when conditioned hydrolyzed feedstock is used, in comparison to identical hydrolyzed feedstock which has not been subjected to the conditioning process.

In some embodiments, a microorganism that is tolerant to inhibitors in hydrolyzed feedstock is used, or the microorganism used for bioproduct production develops increased tolerance to inhibitors over time, e.g., by repeated passaging, rendering the conditioning step unnecessary or uneconomical.

### Compositions

Hydrolysates and conditioned hydrolysates, prepared in accordance with any of the methods described herein, are provided. Such hydrolysate compositions may be used in a downstream process such as microbial fermentation to produce one or more bioproduct(s) of interest. The hydrolysate provides soluble sugar molecules which may be used as a carbon source to support microbial growth and/or bioproduct production. Hydrolysate compositions produced according to the methods disclosed herein advantageously may require minimal processing prior to use in a microbial fermentation process. For example, in some embodiments, the only processing that is required is adjustment of pH to a suitable physiological level for growth of a microorganism of interest. For example, treatment of the hydrolysate using a procedure to remove inhibitors from the hydrolysate composition, as described above, may not be required for the composition to be fermentable by a microorganism.

Biomass material from which hemicellulose has been extracted, prepared in accordance with any of the methods described herein, is also provided. In some embodiments, the biomass material contains cellulosic fiber, e.g., partially hydrolyzed cellulosic fiber, for example, with a length weighted average length of about 0.05 mm to about 1 mm, about 0.1 mm to about 0.5 mm, about 0.2 mm to about 0.4 mm, or about 0.3 mm to about 0.35 mm. Such a material may hydrolyzed, for example, via acid hydrolysis, to release soluble cellulosic sugars, and the cellulosic hydrolysate thus produced may be used, for example, as a carbon source to support microbial growth for production of bioproduct(s) of interest. Alternatively, this material may be subjected to a pulping process to make pulp from the cellulose, and then used as a raw material, for example, for production of paper, rayon, absorbent material, etc.

In some embodiments, solid residue which has been separated from liquid hydrolysate, prepared according to a method disclosed herein, is provided. In some embodiments, the solid material may be used as an energy source, for example, burned to produce energy for hydrolysis of further biomass or for other processes.

In some embodiments, a liquid hydrolysate with soluble sugar molecules, from which solid residue has been separated, prepared according to a method disclosed herein, is provided. In some embodiments, the liquid hydrolysate with soluble sugar molecules may be used to support microbial growth and bioproduct production.

In some embodiments, a hydrolysate that contains both liquid with soluble sugar molecules and solids (e.g., a hydrolysate from which solid residue has not been separated), prepared according to a method disclosed herein, is provided. In some embodiments, the hydrolysate that contains both liquid with soluble sugar molecules and solids may be used to support microbial growth and bioproduct production

A composition that contains biomass material from which hemicellulose has been extracted and one or more polyol (e.g., glycerol; 1,3-propanediol) is also provided herein. In a method in which a polyol has been included in the acid hydrolysis mixture, as described herein, the solid material may contain residual polyol (e.g., glycerol; 1,3-propanediol). In one embodiment, solid material which has been separated from liquid hydrolysate produced in a method in which glycerol was added to acid for hydrolysis of biomass as described herein, contains residual glycerol. In some embodiments, the solid material that contains residual glycerol may be used as an energy source, for example, burned to produce energy for hydrolysis of further biomass or for other processes.

In some embodiments, a liquid hydrolysate that contains soluble sugar molecules and one or more polyol (e.g., glycerol; 1,3-propanediol), prepared by a method which includes addition of one or more polyol as described herein, and from which solid residue has been separated, is provided. In some embodiments, the liquid hydrolysate with soluble sugar molecules and one or more polyol may be used to support microbial growth and bioproduct production.

In some embodiments, a hydrolysate that contains both liquid with soluble sugar molecules and solids (e.g., a hydrolysate from which solid residue has not been separated) and one or more polyol (e.g., glycerol; 1,3-propanediol), prepared by a method which includes addition of one or more polyol as described herein, and from which solid residue has not been separated, is provided. In some embodiments, the hydrolysate that contains both liquid with soluble sugar molecules and solids and one or more polyol may be used to support microbial growth and bioproduct production.

### Methods for Producing a Bioproduct

Methods are provided for producing a bioproduct. The methods include culturing a microorganism in a medium that contains hydrolysate or conditioned hydrolysate, prepared as described herein, as a soluble sugar source to support microbial growth for production of one or more bioproduct(s) of interest. In some embodiments, microbial growth and/or bioproduct titer, yield, and/or productivity may be increased when conditioned hydrolyzed feedstock, prepared as described herein, is used in a microbial fermentation process, in comparison to identical hydrolyzed feedstock which has not been subjected to the conditioning process.

In some embodiments, the bioproduct is a biofuel, for example, butanol, acetone, and/or ethanol. In some embodiments, the bioproduct is solvent (e.g., a polar protic or aprotic solvent), biomolecule, organic acids, alcohols, fatty acid, aldehyde, lipid, long chain organic molecule, vitamin, or sugar alcohol.

### Fermentation

The methods for bioproduct production herein include fermentation of a bioproduct-producing microorganism in a bioreactor in a growth medium that contains hydrolysate or conditioned hydrolysate prepared according to any of the methods described herein.

In some embodiments, the bioproduct production includes fermentation of a bioproduct-producing microorganism in an immobilized cell bioreactor (i.e., a bioreactor containing cells that are immobilized on a support, e.g., a solid support). In some embodiments, an immobilized cell bioreactor provides higher productivity due to the accumulation of increased productive cell mass within the bioreactor compared with a stirred tank (suspended cell) bioreactor. In some embodiments, the microbial cells form a biofilm on the support and/or between support particles in the growth medium.

In other embodiments, for example but not limited to, embodiments in which a hydrolysate composition containing both liquid hydrolysate and solid residues is used, microorganisms may be grown in a non-immobilized system, such as an agitated fermentation reactor, e.g., designed to provide adequate conditions for fermentation, including but not limited to mixing of components, gas removal, temperature control, and/or the ability to add and/or remove material from the reactor. Several fermentation operational moieties exist, including but not limited to batch, fed-batch, and continuous in single or multiple reactor configurations. Exemplar reactor types include but are not limited to agitated tanks, e.g., where agitation is effected by a mechanical impeller, the addition and withdrawal of material, the addition of gas, and/or the recirculation of fermentation gas; corn ethanol fermentation tanks; pharmaceutical fermentation vessels; vacuum fermentation systems; air-lift type reactors; fluidized bed reactors; anaerobic digestors; and activated sludge reactors. In some embodiments, an extractive fermentation process is used (e.g., gas stripping, liquid extraction, vacuum fermentation).

In some embodiments, the bioproduct production process herein includes continuous fermentation of a microorganism (continuous addition of conditioned hydrolyzed feedstock and withdrawal of product stream). Continuous fermentation minimizes the unproductive portions of the fermentation cycle, such as lag, growth, and turnaround time, thereby reducing capital cost, and reduces the number of inoculation events, thus minimizing operational costs and risk associated with human and process error.

Fermentation may be aerobic or anaerobic, depending on the requirements of the bioproduct-producing microorganism.

In some embodiments, an immobilized bioproduct-producing Clostridium strain is fermented anaerobically in a continuous process as described herein.

One or more bioreactors may be used in the bioproduct production systems and processes described herein. When multiple bioreactors are used they can be arranged in series and/or in parallel. The advantages of multiple bioreactors over one large bioreactor include lower fabrication and installation costs, ease of scale-up production, and greater production flexibility. For example individual bioreactors may be taken off-line for maintenance, cleaning, sterilization, and the like without appreciably impacting the production schedule. In embodiments in which multiple bioreactors are used, the bioreactors may be run under the same or different conditions.

In a parallel bioreactor arrangement, hydrolyzed feedstock is fed into multiple bioreactors, and effluent from the bioreactors is removed. The effluent may be combined from multiple bioreactors for recovery of the bioproduct, or the effluent from each bioreactor may be collected separately and used for recovery of the bioproduct.

In a series bioreactor arrangement, hydrolyzed feedstock is fed into the first bioreactor in the series, the effluent from the first bioreactor is fed into a second downstream bioreactor, and the effluent from each bioreactor in the series is fed into the next subsequent bioreactor in the series. The effluent from the final bioreactor in the series is collected and may be used for recovery of the bioproduct.

Each bioreactor in a multiple bioreactor arrangement can have the same species, strain, or mix of species or strains of microorganisms or a different species, strain, or mix of species or strains of microorganisms compared to other bioreactors in the series.

Immobilized cell bioreactors allow higher concentrations of productive cell mass to accumulate and therefore, the bioreactors can be run at high dilution rates, resulting in a significant improvement in volumetric productivity relative to cultures of suspended cells. Since a high density, steady state culture can be maintained through continuous culturing, with the attendant removal of product containing fermentation broth, smaller capacity bioreactors can be used. Bioreactors for the continuous fermentation of C. acetobutylicum are known in the art. (U.S. Pat. Nos. 4,424,275, and 4,568,643.)

Numerous methods of fermentor inoculation are possible including addition of a liquid seed culture to the bottom or the top of the bioreactor and recirculation of the media to encourage growth throughout the bed. Other methods include the addition of a liquid seed culture or impregnated solid support through a port located along the reactor's wall or integrated and loaded with the solid support material. Bioreactor effluent may also be used to inoculate an additional bioreactor and in this case any residual fermentable materials may be converted in the secondary reactor, increasing yield/recovery.

In a similar manner, support material may be added to the reactor through bottom, top, or side loading to replenish support material that becomes degraded or lost from the bioreactor.

### Fermentation Media

Fermentation media for the production of bioproduct may contain feedstock, e.g., a hydrolyzed or conditioned hydrolyzed feedstock, prepared as described herein, as a source of fermentable carbohydrate molecules.

As known in the art, in addition to an appropriate carbon source, fermentation media must contain suitable nitrogen source(s), mineral salts, cofactors, buffers, and other components suitable for the growth of the cultures and promotion of the enzymatic pathway necessary for the production of the desired bioproduct. In some embodiments, salts and/or vitamin B12 or precursors thereof are included in the fermentation media. In some cases, hydrolyzed feedstock may contain some or all of the nutrients required for growth, minimizing or obviating the need for additional supplemental material.

The nitrogen source may be any suitable nitrogen source, including but not limited to, ammonium salts, yeast extract, corn steep liquor (CSL), and other protein sources including, but not limited to, denatured proteins recovered from distillation of fermentation broth or extracts derived from the residual separated microbial cell mass recovered after fermentation. Phosphorus may be present in the medium in the form of phosphate salts, such as sodium, potassium, or ammonium phosphates. Sulfur may be present in the medium in the form of sulfate salts, such as sodium or ammonium sulfates. Additional salts include, but are not limited to, magnesium sulfate, manganese sulfate, iron sulfate, magnesium chloride, calcium chloride, manganese chloride, ferric chloride, ferrous chloride, zinc chloride, cupric chloride, cobalt chloride, and sodium molybdate. The growth medium may also contain vitamins such as thiamine hydrochloride, biotin, and para-aminobenzoic acid (PABA). The growth medium may also contain one or more buffering agent(s) (e.g., MES), one or more reducing agent(s) (e.g., cysteine HCl), and/or sodium lactate, which may serve as a carbon source and pH buffer. Osmoprotectants, such as trehalose, may also be added to the media to mitigate the effects of soluble salts. In some embodiments, molasses is included in the media as a carbon source and/or as a source of nutrients for the microorganism.

### Microorganisms

The systems and processes described herein include one or more microorganism(s) that is (are) capable of producing one or more bioproduct(s) of interest. In embodiments in which two or more microorganisms are used, the microorganisms may be the same or different microbial species and/or different strains of the same species.

In some embodiments, the microorganisms are bacteria or fungi. In some embodiments, the microorganisms are a single species. In some embodiments, the microorganisms are a mixed culture of strains from the same species. In some embodiments, the microorganisms are a mixed culture of different species. In some embodiments, the microorganisms are an environmental isolate or strain derived therefrom.

In some embodiments of the processes and systems described herein, different species or strains, or different combinations of two or more species or strains, are used in different bioreactors with different conditioned hydrolyzed feedstocks as a carbohydrate source.

In some embodiments, a fungal microorganism is used, such as a yeast. Examples of yeasts include, but are not limited to, Saccharomyces cerevisiae, S. bayanus, S. carlsbergensis, S. Monacensis, S. Pastorianus, S. uvarum and Kluyveromyces species. Other examples of anaerobic or aerotolerant fungi include, but are not limited to, the genera Neocallimastix, Caecomyces, Piromyces and other rumen derived anaerobic fungi.

In some embodiments, a bacterial microorganism is used, including Gram-negative and Gram-positive bacteria. Non-limiting examples of Gram-positive bacteria include bacteria found in the genera of Staphylococcus, Streptococcus, Bacillus, Mycobacterium, Enterococcus, Lactobacillus, Leuconostoc, Pediococcus, and Propionibacterium. Non-limiting examples of specific species include Enterococcus faecium and Enterococcus gallinarium. Non-limiting examples of Gram-negative bacteria include bacteria found in the genera Pseudomonas, Zymomonas, Spirochaeta, Methylosinus, Pantoea, Acetobacter, Gluconobacter, Escherichia and Erwinia.

In one embodiment, the bacteria are Clostridium species, including but not limited to, Clostridium saccharobutylicum, Clostridium acetobutylicum, Clostridium beijerinckii, Clostridium puniceum, and environmental isolates of Clostridium.

Further examples of species of Clostridium contemplated for use in this invention can be selected from C. aurantibutyricum, C. butyricum, C. cellulolyticum, C. phytofermentans, C. saccharolyticum, C. saccharoperbutylacetonicum, C. tetanomorphum, C. thermobutyricum, C. thermocellum, C. puniceum, C. thermosaccharolyticum, and C. pasteurianum.

Other bacteria contemplated for use in the processes and systems herein include Corynebacteria, such as C. diphtheriae, Pneumococci, such as Diplococcus pneumoniae, Streptococci, such as S. pyogenes and S. salivarus, Staphylococci, such as S. aureus and S. albus, Myoviridae, Siphoviridae, Aerobic Spore-forming Bacilli, Bacilli, such as B. anthracis, B. subtilis, B. megaterium, B. cereus, Butyrivibrio fibrisolvens, Anaerobic Spore-forming Bacilli, Mycobacteria, such as M. tuberculosis hominis, M. bovis, M. avium, M. paratuberculosis, Actinomycetes (fungus-like bacteria), such as, A. israelii, A. bovis, A. naeslundii, Nocardia asteroides, Nocardia brasiliensis, the Spirochetes, Treponema pallidium, Treponema pertenue, Treponema carateum, Borrelia recurrentis, Leptospira icterohemorrhagiae, Leptospira canicola, Spirillum minus, Streptobacillus moniliformis, Trypanosomas, Mycoplasmas, Mycoplasma pneumoniae, Listeria monocytogenes, Erysipelothrix rhusiopathiae, Streptobacillus monilformis, Donvania granulomatis, Bartonella bacilliformis, Rickettsiae, Rickettsia prowazekii, Rickettsia mooseri, Rickettsia rickettsiae, and Rickettsia conori. Other suitable bacteria may include Escherichia coli, Zymomonas mobilis, Erwinia chrysanthemi, and Klebsiella planticola.

In some embodiments, the microorganisms are from the genera Clostridium, Enterococcus, Klebsiella, Lactobacillus, Enterococcus, Escherichia, Pichia, Pseudomonas, Synechocystis, Saccharomyces, or Bacillus. In some embodiments, the microbial strain is a Clostridium species, for example, Clostridium acetobutylicum, Clostridium beijerinckii, Clostridium saccharobutylicum, Clostridium puniceum, Clostridium saccharoperbutylacetonicum, Clostridium pasteuranium, Clostridium butylicum, Clostridium aurantibutyricum, Clostridium tetanomorphum, Clostridium thermocellum, and Clostridium thermosaccharolyticum. In some embodiments, the microorganisms are obligate anaerobes. Non-limiting examples of obligate anaerobes include Butyrivibrio fibrosolvens and Clostridium species.

In other embodiments, the microorganisms are microaerotolerant and are capable of surviving in the presence of small concentrations of oxygen. In some embodiments, microaerobic conditions include, but are not limited, to fermentation conditions produced by sparging a liquid media with a gas of at least about 0.01% to at least 5% or more O₂ (e.g., 0.01%, 0.05%, 0.10%, 0.50%, 0.60%, 0.70%, 0.80%, 1.00%, 1.20%, 1.50%, 1.75%, 2.0%, 3%, 4%, 5% or more O₂). In another aspect, the microaerobic conditions include, but are not limited to, culture conditions with at least about 0.05 ppm dissolved O₂ or more (e.g., 0.05, 0.075, 0.1, 0.15, 0.2, 0.3, 0.4, 0.5, 0.6, 0.8, 1.0, 2.0, 3.0, 4.0, 5.0, 8.0, 10.0, ppm or more).

Alternatively, parent strains can be isolated from environmental samples such as wastewater sludge from wastewater treatment facilities including municipal facilities and those at chemical or petrochemical plants. The latter are especially attractive as the isolated microorganisms can be expected to have evolved over the course of numerous generations in the presence of high product concentrations and thereby have already attained a level of desired product tolerance that may be further improved upon.

Parent strains may also be isolated from locations of natural degradation of naturally occurring feedstocks and compounds (e.g., a woodpile, a saw yard, under fallen trees, landfills). Such isolates may be advantageous since the isolated microorganisms may have evolved over time in the presence of the feedstock and thereby have already attained some level of conversion and tolerance to these materials that may be further improved upon.

Individual species or mixed populations of species can be isolated from environmental samples. Isolates, including microbial consortiums can be collected from numerous environmental niches including soil, rivers, lakes, sediments, estuaries, marshes, industrial facilities, etc. In some embodiments, the microbial consortiums are strict anaerobes. In other embodiments, the microbial consortiums are obligate anaerobes. In some embodiments, the microbial consortiums are facultative anaerobes. In still other embodiments, the microbial consortiums do not contain species of Enterococcus or Lactobacillus.

When mixed populations of specific species or genera are used, a selective growth inhibitor for undesired species or genera can be used to prevent or suppress the growth of these undesired microorganisms.

### Culture Conditions

Optimal culture conditions for various industrially important microorganisms are known in the art. As required, the culture conditions may be anaerobic, microaerotolerant, or aerobic. Aerobic conditions are those that contain oxygen dissolved in the media such that an aerobic culture would not be able to discern a difference in oxygen transfer with the additional dissolved oxygen, and microaerotolerant conditions are those where some dissolved oxygen is present at a level below that found in air or air saturated solutions and frequently below the detection limit of standard dissolved oxygen probes, e.g., less than 1 ppm. The cultures can be agitated or left undisturbed. Typically, the pH of the media changes over time as the microorganisms grow in number, consume feedstock and excrete organic acids. The pH of the media can be modulated by the addition of buffering compounds to the initial fermentation media in the bioreactor or by the active addition of acid or base to the growing culture to keep the pH in a desired range. Growth of the culture may be monitored by measuring the optical density, typically at a wavelength of 600 nm, or by other methods known in the art.

Clostridium fermentations are generally conducted under anaerobic conditions. For example, ABE fermentations by C. acetobutylicum are typically conducted under anaerobic conditions at a temperature in the range of about 25° C. to about 40° C. Historically, suspension cultures did not use agitators, but relied on evolved or sparged gas to mix the contents of the bioreactors. Cultures, however, can be agitated to ensure more uniform mixing of the contents of the bioreactor. For immobilized cultures, a bioreactor may be run without agitation in a fixed bed (plug flow) or fluidized/expanded bed (well-mixed) mode. Thermophilic bacterial fermentations can reach temperatures in the range of about 50° C. to about 80° C. In some embodiments, the temperature range is about 55° to about 70° C. In some embodiments, the temperature range is about 60° C. to about 65° C. For example, Clostridium species such as C. thermocellum or C. thermohydrosulfuricum may be grown at about 60° C. to about 65° C. The pH of the Clostridium growth medium can be modulated by the addition of buffering compounds to the initial fermentation media in the bioreactor or by the active addition of acid or base to the growing culture to keep the pH in a desired range. For example, a pH in the range of about 3.5 to about 7.5, or about 5 to about 7, may be maintained in the medium for growth of Clostridium.

### Immobilization of Microorganisms on Solid or Semi-Solid Support

Optionally, microorganisms are grown immobilized on a solid or semi-solid support for production of one or more bioproduct(s) of interest.

Immobilization of the microorganism, from spores or vegetative cells, can be by any known method. In one embodiment, entrapment or inclusion in the support is achieved by polymerizing or solidifying a spore or vegetative cell containing solution. Useful polymerizable or solidifiable solutions include, but are not limited to, alginate, κ-carrageenan, chitosan, polyacrylamide, polyacrylamide-hydrazide, agarose, polypropylene, polyethylene glycol, dimethyl acrylate, polystyrene divinyl benzene, polyvinyl benzene, polyvinyl alcohol, epoxy carrier, cellulose, cellulose acetate, photocrosslinkable resin, prepolymers, urethane, and gelatin.

In another embodiment, the microorganisms are incubated in growth medium with a support. Useful supports include, but are not limited to, bone char, cork, clay, resin, sand, porous alumina beads, porous brick, porous silica, celite (diatomaceous earth), polypropylene, polyester fiber, ceramic, (e.g., porous ceramic, such as porous silica/alumina composite), lava rock, vermiculite, ion exchange resin, coke, natural porous stone, macroporous sintered glass, steel, zeolite, engineered thermal plastic, concrete, glass beads, Teflon, polyetheretherketone, polyethylene, wood chips, sawdust, cellulose fiber (pulp), or other natural, engineered, or manufactured products. The microorganisms may adhere to the support and form an aggregate, e.g., a biofilm.

In another embodiment, the microorganism is covalently coupled to a support using chemical agents like glutaraldehyde, o-dianisidine (U.S. Pat. No. 3,983,000), polymeric isocyanates (U.S. Pat. No. 4,071,409), silanes (U.S. Pat. Nos. 3,519,538 and 3,652,761), hydroxyethyl acrylate, transition metal-activated supports, cyanuric chloride, sodium periodate, toluene, or the like. See also U.S. Pat. Nos. 3,930,951 and 3,933,589.

In one embodiment, immobilized spores, such as those of Clostridium, e.g., C. acetobutylicum, are activated by thermal shock and then incubated under appropriate conditions in a growth medium whereby vegetative growth ensues. These cells remain enclosed in or on the solid support. After the microorganisms reach a suitable density and physiological state, culture conditions can be changed for bioproduct production. If the immobilized cells lose or exhibit reduced bioproduct production ability, they can be reactivated by first allowing the cells to sporulate before repeating the thermal shock and culture sequence.

Vegetative cells can be immobilized in different phases of their growth. For microorganisms that display a biphasic culture, such as C. acetobutylicum with its acidogenic and solventogenic phases, cells can be immobilized after they enter the desired culture phase in order to maximize production of the desired products, where in the case of C. acetobutylicum it is the organic acids acetic acid and butyric acid in the acidogenic phase and the solvents acetone, butanol and ethanol in the solventogenic phase. Alternatively, biphasic cells can be immobilized in the acidogenic phase and then adapted for solvent production.

In some embodiments, microorganisms to be immobilized in a bioreactor are introduced by way of a cell suspension. Generally, these microorganisms are dispersed in the media as single cells or small aggregates of cells. In other embodiments, the microorganisms are introduced into the bioreactor through the use of suspended particles that are colonized by the microorganisms. These suspended particles can be absorbed onto the solid support and frequently are of sufficiently small size that they can enter and become immobilized in the pore structures of the solid support. Typically, regardless of the suspended particle size, microorganisms can be transferred by contact with the solid support. A biofilm on the introduced particles can transfer to and colonize these new surfaces. In some embodiments, the desired characteristics of the microorganisms can only be maintained by culturing on a solid support, thereby necessitating the use of small colonized particle suspensions for seeding a solid support in a bioreactor.

### Support for Immobilized Microbial Growth

In some embodiments, a bioproduct producing microorganism is grown in an immobilized form on a solid or semi-solid support material in a bioreactor as described herein. In some embodiments, the support contains a porous material. Non-limiting examples of suitable support materials include bone char, synthetic polymers, natural polymers, inorganic materials, and organic materials.

Natural polymers include organic materials such as cellulose, lignocellulose, hemicellulose, and starch. Organic materials include feedstock such as plant residue and paper. Composites of two or more materials may also be used such as mixtures of synthetic polymer with natural plant polymer.

Examples of semi-solid media include alginate, κ-carrageenan and chitosan, polyacrylamide, polyacrylamide-hydrazide, agarose, polypropylene, polyethylene glycol, dimethyl acrylate, polystyrene divinyl benzene, polyvinyl benzene, polyvinyl alcohol, epoxy carrier, cellulose, cellulose acetate, photocrosslinkable resin, prepolymers, urethane, and gelatin. Examples of solid support include cork, clay, resin, sand, porous alumina beads, porous brick, porous silica, celite, wood chips or activated charcoal.

Suitable inorganic solid support materials include inorganic materials with available surface hydroxy or oxide groups. Such materials can be classified in terms of chemical composition as siliceous or nonsiliceous metal oxides. Siliceous supports include, inter alia, glass, colloidal silica, wollastonite, cordierite, dried silica gel, bentonite, and the like. Representative nonsiliceous metal oxides include alumina, hydroxy apatite, and nickel oxide.

In some embodiments, the support material is selected from bone char, polypropylene, steel, diataomaceous earth, zeolite, ceramic, (e.g., porous ceramic, such as porous silica/alumina composite), engineered thermal plastic, clay brick, concrete, lava rock, wood chips, polyester fiber, glass beads, Teflon, polyetheretherketone, polyethylene, vermiculite, ion exchange resin, cork, resin, sand, porous alumina beads, coke, natural porous stone, macroporous sintered glass, or a combination thereof. In one embodiment, the support material is bone char. Useful support material has a high surface area to volume ratio such that a large amount of active, productive cells can accumulate in the bioreactor. Useful supports may contain one or more macrostructured components containing one or more useful support material(s) that promotes good fluidmechanical properties, for example, a wire mesh/gauze packing material used for traditional distillation tower packing.

In some embodiments, the support material includes a surface area of at least about 100 m²/m³. In some embodiments, the support material comprises a bulk density of at least about 0.15 g/cm³. In some embodiments, the support material comprises a ball-pan hardness number of at least about 60. In some embodiments, the support material comprises a yield strength of at least about 20 MPa.

The particle size for the support material will vary depending upon bioreactor configuration and operation parameters. In some embodiments, the support material is sized by sieving. In some embodiments, the particles are classified by the sieve number of the mesh that they can pass through. In some embodiments, the particles are sieved with a mesh that has a U.S. Sieve Number of 3½, 4, 5, 6, 7, 8, 10, 12, 14, 16, 18, 20, 25, 30, 35, 40, 45, 50, 60, or 70. In some embodiments, the particles are sieved at least twice, first using a mesh with larger openings followed by a mesh with smaller openings to yield particles within a defined particle size distribution range. In some embodiments, the particles are at least about 100 μm, 200 μm, 300 μm, 400 μm, 500 μm, 600 μm, 700 μm, 800 μm, 900 μm, 1000 μm, 1,100 μm, 1,200 μm, 1,300 μm, 1,400 μm, 1,500 μm, 1,600 μm, 1,700 μm, 1,800 μm, 1,900 μm, 2,000 μm, 3,000 μm, 4,000 μm, 5,000 μm, 6,000 μm, 7,000 μm, 8000 μm, 9,000 μm, 10,000 μm, 12,500 μm, 15,000 μm, 17,500 μm, 20,000 μm, 22,500 μm, or 25,000 μm in diameter. In some embodiments, the particles are less than about 100 μm, 200 μm, 300 μm, 400 μm, 500 μm, 600 μm, 700 μm, 800 μm, 900 μm, 1000 μm, 1,100 μm, 1,200 μm, 1,300 μm, 1,400 μm, 1,500 μm, 1,600 μm, 1,700 μm, 1,800 μm, 1,900 μm, 2,000 μm in diameter. In further embodiments, at least about 80%, 85%, 90%, 95%, or 100% of the particle have diameters that are in the range of about 100-400 μm, 100-600 μm, 100-800 μm, 200-500 μm, 200-800 μm, 200-1000 μm, 400-800 μm, 400-1000 μm, 500-1000 μm, 600-1,200 μm, 800-1,400, μm 1,000-1,500, μm 1,000-2000 μm, 2,000-4,000 μm, 4,000-6,000 μm, 5,000-12,000 μm, 3,000-15,000 μm, or 6,000-25,000 μm. In some embodiments, the particle diameters are the equivalent diameters, a parameter that takes into account the irregular shapes of the individual particles.

Ideally, the semi-solid or solid support material should have a high surface area. This can be achieved through the use of small sized particles, particles with high porosity, or a combination thereof. In some embodiments, the surface area of the particles is at least about 0.003 m²/g, 0.01 m²/g, 0.02 m²/g, 0.05 m²/g, 0.1 m²/g, 0.5 m²/g, 1 m²/g, 5 m²/g, 10 m²/g, 25 m²/g, 50 m²/g, 75 m²/g, 100 m²/g, 125 m²/g, 150 m²/g, 175 m²/g, 200 m²/g, 225 m²/g, 250 m²/g, 275 m²/g, 300 m²/g, 325 m²/g, 350 m²/g, 375 m²/g, 400 m²/g, 425 m²/g, 450 m²/g, 500 m²/g, 600 m²/g, 700 m²/g, 800 m²/g, 900 m²/g, 1000 m²/g, or 2000 m²/g. Additionally, the bulk density should be sufficiently high so that the smallest particles settle out of the fluid stream in the column expansion zone and/or particle disengagement zone and are thereby retained in the bioreactor. In some embodiments, the bulk density of the support is at least about 0.1 g/cm³, 0.2 g/cm³, 0.3 g/cm³, 0.4 g/cm³, 0.5 g/cm³, 0.6 g/cm³, 0.7 g/cm³, 0.8 g/cm³, 0.9 g/cm³, 1.0 g/cm³, 1.1 g/cm³, 1.2 g/cm³, or 1.3 g/cm³. The support material should have sufficient hardness to resist abrasion and thereby avoid appreciable dust formation when the support particles touch or collide with each other. In some embodiments, the support has a ball-pan hardness number of at least about 20, 40, 60, 80, 100, 120, 140, 160 or 200. The support material should also have sufficient tensile strength to resist shattering due to internal stresses, which may be caused by the growth of biofilms inside support material pores. In some embodiments, the support has a yield strength of at least about 20 MPa, 40 MPa, 60 MPa, 80 MPa, 100 MPa, 120 MPa, 140 MPa, 160 MPa, 180 MPa, 200 MPa, 300 MPa, or 400 MPa. The support material should also have the ability to resist being crushed by the accumulated weight of material above it. Crush strength is another measurement of the mechanical strength of the support and is typically a function of the composition, shape, size, and porosity of the material (increase in port volume may negatively impact particle strength). In some embodiments, the crush strength is at least about 8 kg.

In some embodiments, the support material is chosen to support growth of the fermenting bioproduct producing microorganism as a biofilm. The biofilm may grow on exterior surfaces of support particles, in the fluid space between support particles, and/or on surfaces in the interior of pores of the support material.

### Continuous Process

In some embodiments, a continuous process for bioproduct production is provided. In a continuous production process herein, a carbohydrate-containing feedstock hydrolysate or conditioned hydrolysate containing soluble sugar molecules, prepared according to any of the methods described herein, is continuously fed to one or more bioreactors for microbial production of the bioproduct, the bioproduct is continuously produced by immobilized microorganism(s) in the one or more bioreactors, and bioproduct-containing effluent, i.e., fermentation broth, is continuously withdrawn from the one or more reactors, for the duration of fermentation. In some embodiments, feedstock is continuously hydrolyzed to release soluble sugar molecules, and continuously conditioned prior to introduction of the conditioned hydrolyzed feedstock into the bioreactor(s). The conditioning process may operate continuously downstream from a feedstock hydrolysis process, and upstream from the bioreactor(s), and conditioned hydrolyzed feedstock may be continuously fed to the bioreactor for the duration of fermentation. In some embodiments, the microorganism is tolerant to inhibitors and the conditioning step is not used. In one embodiment, the feedstock is lignocellulosic feedstock, and is hydrolyzed with nitric acid to release soluble sugar molecules from and hemicellulose and optionally cellulose, as described supra.

In some embodiments, the continuous process may also include downstream continuous concentration and/or purification processes for recovery of the bioproduct, wherein continuously withdrawn effluent is continuously processed in one or more concentration and/or purification processes to produce a bioproduct.

In some embodiments, the process may also include deconstruction of the feedstock and/or removal of extractives from the feedstock, as described herein. Deconstruction and/or removal of extractives may be continuous or may occur prior to or periodically throughout the continuous process.

In some embodiments, the process operates continuously for at least about 50, 100, 200, 300, 400, 600, 800, 1000, 1350, 1600, 2000, 2500, 3000, 4000, 5000, 6000, 7000, 8000, or 8400 hours

A “continuous” process as described herein may include periodic or intermittent partial or complete shutdowns of one or more parts of the bioproduct production system for processes such as maintenance, repair, regeneration of resin, etc.

Continuous fermentation, with constant feed of feedstock and withdrawal of product-containing microbial broth, can minimize the unproductive portions of a fermentation cycle, such as lag, growth, and turnaround time, thereby reducing the capital cost, and can reduce the number of inoculation events, thus minimizing operational costs and risk associated with human and process error.

The continuous methods and systems described herein can utilize one or more, e.g., one, two, or three or more, bioreactors. When multiple (two or more) bioreactors are used, they may be arranged in parallel, series, or a combination thereof. The bioreactors can grow the same or different strains of microorganism(s).

In other embodiments, a batch process is used, with shorter fermentation times, e.g., about 20 hours, about 24 hours, about 48 hours, or about 72 hours. In some embodiments, a batch fermentation process operates for about 20 hours to about 72 hours, or about 24 hours to about 48 hours.

The following examples are intended to illustrate, but not limit, the invention.

### EXAMPLES

### Example 1

Bagasse from two different sources was pretreated with nitric acid for hemicellulose extraction. 85 g of acid was used per kilogram of bagasse, accounting for buffering capacity of the bagasse and the water stream available from city water. A chip refiner (Andritz Fiber Refiner 401) was utilized to mix the acid, water, and bagasse. The plate spacing was set wide open to minimize any milling action on the bagasse while providing sufficient mixing. The machine output was to 55 gallon drums.

The acid impregnated material was elevated via a barrel lift that carried the drums to a plug screw feeder at the top of the digester. The feeder maintained a plug at its output that held the pressure and temperature of the subsequent plug flow reactor constant. The plug flow reactor temperature was set by adjusting the steam pressure (direct injection of steam) to 25-30 psi (pounds per square inch), providing a reaction temperature of 130° C. The reactor retention time was set to 35 minutes by adjusting the screw conveyer speed in the reactor. The liquid was separated from the residual material through the use of an Andritz model 560 screw press with an 8:1 compression ratio. Some small quantities of analytical samples were separated from the solids via filtration and/or centrifugation.

The composition of the liquid hydrolysate obtained is shown in Table 1.

TABLE 1
Pressate Composition

| | |
|---|---|
| Run No. 1 | Run No. 2 |

| | |
|---|---|
| Component | Concentration (g/L) |

| | | |
|---|---|---|
| Glucose | 6 | 5 |
| Xylose | 57 | 61 |
| Arabinose | 6 | 8 |
| Mannose | 0 | 0 |
| Galactose | 0 | 0 |
| Lactic Acid | 3.11 | 1.22 |
| Glycerol | 0.00 | 0.38 |
| Formic Acid | 0.55 | 0.71 |
| Acetic Acid | 4.84 | 4.68 |
| Levulinic Acid | 0.19 | 0.47 |
| HMF | 0.13 | 0.18 |
| Furfural | 0.10 | 0.09 |
| Total | 69 | 74 |
| monomeric | | |
| sugars | | |

The data in Table 1 is for two separate batch runs of sugar cane bagasse. Run No. 1 was with bagasse collected from Louisiana (North America) and was stored in piles protected from rain and allowed to reach equilibrium with the ambient conditions over a period greater than 12 months. Run No. 2 was with bagasse collected from an unprotected storage pile at a sugar mill site in Brazil (South America) and transported in drums to the test site. The approximate time period from harvest to usage was estimated to be less than two months.

Samples were analyzed by HPLC using a procedure based on National Renewable Energy Laboratory Technical Report NREL/TP-510-42623 (January, 2008). Compositional analysis included monomeric sugars, organic acids, glycerol, hydroxymethyl furfural (HMF), and furfural. Generally, lactic and acetic acids do not inhibit the fermentation process at levels normally found in the biomass hydrolysates. The hemicellulose contains acetyl groups that become acetic acid upon hydrolysis. Lactic acid is usually the product of fermentation by a lacto bacillus. For sugar cane bagasse, the bagasse pile that the samples were taken from can be ensiling (fermenting) and producing lactic and acetic acid. Levulinic acid and HMF are degradation products of glucose. Levulinic acid may inhibit the fermentation process and the amount in Run No. 2 may provide low levels of inhibition to microorganisms used for butanol fermentation. Formic acid and furfural are degradation products of xylose. Formic acid is or can be an inhibitory compound to the fermentation, while furfural is only inhibitory at higher concentrations.

The process outputs are shown in Tables 2 and 3.

TABLE 2
Process outputs and related yields.

| | Run | Run | Average of |
|---|---|---|---|
| | 1 | 2 | the 2 runs |
| Kg sugar produced | 70.0 | 74.1 | 72.0 |
| % of total sugar produced | 32.3 | 34.1 | 33.2 |
| (216.9 Kg) | | | |
| Kg glucose produced | 6.0 | 5.0 | 5.5 |
| Kg xylose and arabinose | 64.0 | 66.0 | 65.0 |
| produced | | | |
| Kg non-sucrose oligomers | 1.3 | 2.2 | 1.8 |
| produced | | | |
| Kg sugar produced per | 0.1 | 0.1 | 0.1 |
| Kg of bagasse processed | | | |
| % Discharge solids (w/w) | 14.2 | 17.0 | 15.6 |

Characteristics of the residual cellulose fiber are provided in Table 3.

TABLE 3
Residual Fiber Characteristics

| | Run 1 | Run 2 |
|---|---|---|
| Coarseness (mg/m) | 0.52 | 0.57 |
| Length weighted | 0.30 | 0.33 |
| average length (mm) | | |
| Arithmetic average | 0.18 | 0.19 |
| length (mm) | | |
| Weight weighted | 0.64 | 0.73 |
| average length (mm) | | |
| Average width (um) | 38.81 | 41.78 |
| Surface area (m²/kg) | 4860.00 | 2724.00 |

Fiber classifications are shown in Table 4.

TABLE 4
Fiber Classifications

| | Run 1 | Run 2 |
|---|---|---|
| % on 14 mesh | 4.60 | 1.90 |
| % on 28 mesh | 7.60 | 13.80 |
| % on 48 mesh | 13.70 | 16.50 |
| % on 100 mesh | 9.60 | 10.10 |
| % on 200 mesh | 17.40 | 17.40 |
| % through 200 mesh | 47.10 | 40.30 |

These sugar streams were fermentable at 45 to 50 g/L sugar, without procedures for removal of inhibitors. The pH of liquid hydrolysate from each of the runs was adjusted to 6.5-7. Corn steep powder (7 g/l), and trace salts (magnesium sulfate, manganese sulfate, ferrous sulfate, and citric acid monohydrate) were added to the hydrolysate. A butanol-producing Clostridium strain from a seed train grown in yeast extract medium (YEM) was inoculated into 4 ml of hydrolysate at a 1:10 dilution and fermented anaerobically for 72 hours. Fermentations were carried out in an anaerobic hood at a temperature of about 30° C. Butanol was produced at a titer of 11 g/l with hydrolysate produced in Run No. 1 and at a titer of 12 g/l with hydrolysate produced in Run No. 2.

### Example 2

Bagasse from Louisiana was used for this experiment. The pretreatment took place in the Parr Reactor model 4524 and Parr Reactor Controller model 4843. The raw bagasse was mixed with nitric acid (68%), glycerol, and water inside of a mixing bag. The acid loading was at 27.2 kg/MT, the glycerol loading was at 23.31 kg/MT, and the solid loading was at 20% dry weight. The total mass of this mixture was at 350 grams. Once the mixture had been thoroughly mixed, the mixture was then loaded into the reaction cylinder of the Parr Reactor.

After the loading was finished, the reactor cylinder was then assembled with the reactor head. Thermocouple probes were then inserted into the reactor assembly. The reactor assembly was then heated in a heating jacket. By adjusting the temperature from the reactor controller (Parr model 4843), the temperature inside the reaction cylinder can be within +5° C. or −5° C. of the target reaction temperature. The agitator of the Parr Reactor was turned on once the temperature was greater than 90° C. Once the temperature reached within 3° C. of the reaction temperature (about 15-17 minutes), the experiment run time began. The psi reading from the Parr Reactor was 25-40 psi. Two separate runs were performed for this experiment. One run was performed at 145° C. for 35 min while the second run was done at 150° C. for 25 min.

After the run was completed, the Parr Reactor was cooled in a bucket of ice water to rapidly quench the reaction. Once the temperature was lower than 20° C., the release valve on the Parr Reactor head was opened to vent the pressure inside of the reaction cylinder. The biomass material was then removed from the reaction cylinder and pressed in a 6 ton hydraulic press to undergo solid and liquid separation. A small sample of the liquid hydrolysate was removed for HPLC analysis. HPLC analysis was performed as described in Example 1. The results are shown in Table 5 below.

TABLE 5
Pressate Composition

| | Run 1 | Run 2 |
|---|---|---|
| | (150° C. for 25 min) | (145° C. for 35 min) |
| Component | Concentration (g/L) | |
| Glucose | 4.217 | 4.177 |
| Xylose/Mannose/Galactose | 41.572 | 40.409 |
| Arabinose | 10.812 | 11.309 |
| Glycerol | 7.269 | 7.512 |
| Acetic Acid | 10.91 | 10.865 |
| HMF | 0.195 | 0.168 |
| Furfural | 3.428 | 3.773 |
| Total sugars | 56.601 | 55.895 |

### Example 3

A hydrolysate recycle experiment was performed in batch mode with sugarcane bagasse as the biomass. A combination of nitric acid and crude glycerol (about 60% by weight) from biodiesel production were used for acid hydrolysis. The reaction components and amounts used for the acid hydrolysis reaction are shown in Table 6.

TABLE 6

| Reactant | Mass Percentage |
|---|---|
| Bagasse (dry) | 30.00% |
| Nitric Acid | 0.816% |
| Glycerol | 0.554% |
| Balance Water | 68.63% |
| Total Weight | 7000 g |

Hydrolysis was performed in a reactor placed in an autoclave set to a temperature of 130° C. for 120 minutes (about 25 psig). The resulting treated biomass was pressed at 700 psi in a 20 ton hydraulic press to separate liquid from solid residue. The liquid was then used as a recycle stream for another cycle of biomass hydrolysis.

For the next cycle, reactants were replenished back to the concentration levels described in Table 7, and the pH was adjusted to 1.2 with nitric acid. Hydrolysis was then performed in a reactor placed in an autoclave set to a temperature of 130° C. for 120 minutes.

40 cycles of hydrolysis and recycle were performed as described above. For cycles #1 to #13, the reactions were performed in borosilicate jars. For cycles #14 to #18, the reactions were performed in Nalgene trays. For cycles #19 to #40, the reactions were performed in stainless steel trays. The reactor materials were changed over time achieve improved heat transfer.

To achieve a substantially constant heat gradient across the reactor bed, the biomass and other reactants were spread evenly in the trays with a cake height of about 1.5 inches. The trays were then placed in an autoclave for heating at 130 performed in a reactor placed in an autoclave set to a temperature of 130° C. for 120 minutes.

Samples were analyzed by HPLC as described in Example 1. The results from the 40 cycle run are shown in Tables 7 and 8 below.

TABLE 7

| | Sucrose and | | | | Total |
|---|---|---|---|---|---|
| Recycle | Other Small | | | | Sugar |
| # | Oligomers (g/L) | Glucose | XMG | Arabinose | (g/L) |
| 5 | 2.8926 | 4.776 | 59.755 | 5.924 | 70.46 |
| 10 | 7.417 | 3.754 | 51.864 | 6.982 | 62.60 |
| 15 | 18.627 | 4.87 | 76.041 | 14.272 | 95.18 |
| 20 | 15.626 | 4.718 | 69.562 | 12.114 | 86.39 |
| 25 | 20.206 | 4.649 | 67.597 | 15.612 | 87.86 |
| 30 | 20.127 | 7.539 | 91.774 | 14.652 | 113.97 |
| 35 | 16.406 | 6.575 | 88.413 | 13.924 | 108.91 |
| 40 | 23.1 | 7.916 | 90.284 | 23.305 | 121.51 |

TABLE 8

| | | Acetic | | |
|---|---|---|---|---|
| Recycle # | Glycerol | Acid | HMF | Furfural |
| 5 | 3.839 | 8.387 | 0.162 | 1.431 |
| 10 | 3.667 | 7.781 | 0.165 | 1.246 |
| 15 | 6.721 | 12.269 | 0.271 | 1.128 |
| 20 | 6.373 | 11.741 | 0.186 | 1.358 |
| 25 | 6.611 | 11.688 | 0.403 | 1.089 |
| 30 | 6.841 | 15.55 | 0.397 | 3.15 |
| 35 | 5.227 | 13.518 | 0.381 | 2.305 |
| 40 | 7.395 | 17.67 | 0.747 | 3.007 |

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention, which is delineated in the appended claims.

All publications, patents, and patent applications cited herein are hereby incorporated by reference in their entireties for all purposes and to the same extent as if each individual publication, patent, or patent application were specifically and individually indicated to be so incorporated by reference.

We claim:

1. A method for extracting sugar molecules from biomass, comprising:
(a) contacting biomass with about 0.5% nitric acid (w/w), about 0.5% glycerol (w/w), and water, thereby producing acid impregnated biomass; and
(b) feeding the acid impregnated biomass into a digestor through a pressure changing device, wherein the acid impregnated biomass is heated in the digestor at about 140° C. to about 145° C. for about 40 minutes to about 45 minutes, thereby producing a composition that comprises a liquid hydrolysate and residual solids, wherein the liquid hydrolysate comprises soluble sugar molecules.

2. A method according to claim 1, wherein said glycerol is added in a crude glycerol composition that comprises about 60% to about 80% glycerol by weight.

3. A method according to claim 1, wherein said biomass comprises bagasse.

4. A method according to claim 1, wherein said biomass is mechanically disintegrated prior to or in conjunction with step (a).

5. A method for producing a bioproduct, comprising culturing a microorganism that produces the bioproduct in a medium that comprises a composition that comprises soluble sugar molecules, under conditions suitable for production of the bioproduct, wherein said composition that comprises soluble sugar molecules is produced according to claim 1.

6. A method according to claim 5, wherein said bioproduct comprises at least one solvent.

7. A method according to claim 6, wherein said at least one solvent comprises butanol, ethanol, and/or acetone.

8. A method for extracting sugar molecules from biomass, comprising:
(a) contacting a first biomass with acid at a concentration sufficient to depolymerize a polymeric carbohydrate component from the first biomass, thereby producing acid impregnated first biomass;
(b) feeding the acid impregnated first biomass into a digestor through a pressure changing device, wherein the acid impregnated first biomass is heated in the digestor at a temperature and for an amount of time sufficient to permit hydrolysis to occur, thereby producing a composition that comprises a first liquid hydrolysate and first residual solids, wherein the first liquid hydrolysate comprises soluble sugar molecules;
(c) separating the first liquid hydrolysate from the first residual solids;
(d) contacting a second biomass with the first liquid hydrolysate, thereby producing acid impregnated second biomass; and
(e) feeding the acid impregnated second biomass into a digestor through a pressure changing device, wherein the acid impregnated second biomass is heated in the digestor at a temperature and for an amount of time sufficient to permit hydrolysis to occur, thereby producing a composition that comprises a second liquid hydrolysate and second residual solids, wherein the second liquid hydrolysate comprises soluble sugar molecules, and wherein the amount of soluble sugar molecules in the second liquid hydrolysate is greater than the amount of soluble sugar molecules in the first liquid hydrolysate.

9. A method according to claim 8, wherein the first biomass is mechanically disintegrated prior to or in conjunction with step (a).

10. A method according to claim 8, wherein the acid concentration in step (a) is about 0.7% (w/w) to about 1.5% (w/w), the digestor in step (b) is operated at a temperature of about 100° C. to about 160° C. with a residence time of about 10 minutes to about 120 minutes, and the digestor in step (e) is operated at a temperature of about 100° C. to about 160° C. with a residence time of about 10 minutes to about 120 minutes.

11. A method according to claim 8, wherein the acid concentration in step (a) is about 0.8% (w/w) to about 1.2% (w/w), the digestor in step (b) is operated at a temperature of about 110° C. to about 140° C. with a residence time of about 20 minutes to about 90 minutes, and the digestor in step (e) is operated at a temperature of about 110° C. to about 140° C. with a residence time of about 20 minutes to about 90 minutes.

12. A method according to claim 8, wherein the acid concentration in step (a) is about 0.9% (w/w) to about 1.2% (w/w), the digestor in step (b) is operated at a temperature of about 120° C. to about 130° C. with a residence time of about 45 minutes to about 60 minutes, and the digestor in step (e) is operated at a temperature of about 120° C. to about 130° C. with a residence time of about 45 minutes to about 60 minutes.

13. A method according to claim 8, comprising contacting the first biomass with a polyol, wherein the polyol is added separately from the acid in step (a) or simultaneously with the acid in step (a).

14. A method according to claim 13, wherein the polyol comprises glycerol.

15. A method according to claim 14, wherein the glycerol is added in a crude glycerol composition that comprises about 60% to about 80% glycerol by weight.

16. A method according to claim 14, wherein glycerol is included in step (a) at a concentration of about 0.3% (w/w) to about 1.2% (w/w).

17. A method according to claim 16, wherein the acid in step (a) is nitric acid at a concentration of about 0.3% (w/w) to about 1.2% (w/w).

18. A method according to claim 8, wherein step (a) comprises contacting the first biomass with about 0.5% (w/w) nitric acid and about 0.5% (w/w) glycerol, wherein the digestor in step (b) is operated at a temperature of about 140° C. to about 145° C. with a residence time of about 40 minutes to about 45 minutes, and wherein the digestor in step (e) is operated at a temperature of about 140° C. to about 145° C. with a residence time of about 40 minutes to about 45 minutes.

19. A method according to claim 8, wherein the biomass comprises bagasse.

20. A method for producing a bioproduct, comprising culturing a microorganism that produces the bioproduct in a medium that comprises a composition that comprises soluble sugar molecules, under conditions suitable for production of the bioproduct,
wherein said composition that comprises soluble sugar molecules is a second liquid hydrolysate produced according to claim 8.

21. A method according to claim 20, wherein said bioproduct comprises at least one solvent.

22. A method according to claim 21, wherein said at least one solvent comprises butanol, ethanol, and/or acetone.

23. A method for extracting sugar molecules from biomass, comprising:
(a) contacting biomass with acid at a concentration of about 0.7% (w/w) to about 1.5% (w/w), thereby producing acid impregnated first biomass; and
(b) feeding the acid impregnated first biomass into a digestor through a pressure changing device, wherein the acid impregnated biomass is heated in the digestor at a temperature about 100° C. to about 160° C., and wherein the residence time in the digestor is about 10 minutes to about 120 minutes, thereby producing a composition that comprises soluble sugar molecules.

24. A method according to claim 23, wherein the composition that comprises soluble sugar molecules comprises a liquid hydrolysate and residual solids, and wherein the method further comprises:
(c) separating the liquid hydrolysate from the residual solids.

25. A method according to claim 23, wherein the acid concentration in step (a) is about 0.8% (w/w) to about 1.2% (w/w), wherein the temperature in the digestor in step (b) is about 110° C. to about 140° C., and wherein the residence time in the digestor in step (b) is about 20 minutes to about 90 minutes.

26. A method according to claim 23, wherein the acid concentration in step (a) is about 0.9% (w/w) to about 1.2% (w/w), wherein the temperature in the digestor in step (b) is about 120° C. to about 130° C., and wherein the residence time in the digestor in step (b) is about 45 minutes to about 60 minutes.

27. A method according to claim 23, wherein the biomass is mechanically disintegrated prior to or in conjunction with step (a).

28. A method according to claim 23, comprising contacting the biomass with a polyol, wherein the polyol is added separately from the acid in step (a) or simultaneously with the acid in step (a).

29. A method according to claim 28, wherein the polyol comprises glycerol.

30. A method according to claim 29, wherein the glycerol is added in a crude glycerol composition that comprises about 60% to about 80% glycerol by weight.

31. A method according to claim 23, wherein the acid concentration in step (a) is about 0.3% (w/w) to about 1.2% (w/w), and wherein glycerol is included in step (a) at a concentration of about 0.3% (w/w) to about 1.2% (w/w).

32. A method according to claim 23, wherein the biomass comprises bagasse.

33. A method for producing a bioproduct, comprising culturing a microorganism that produces the bioproduct in a medium that comprises a composition that comprises soluble sugar molecules, under conditions suitable for production of the bioproduct,
wherein said composition that comprises soluble sugar molecules is produced according to claim 23.

34. A method according to claim 33, wherein said bioproduct comprises at least one solvent.

35. A method according to claim 34, wherein said at least one solvent comprises butanol, ethanol, and/or acetone.
